(19) United States
(12) Patent Application Publication
(10) Pub. No.: US 2007/0298245 A1
(43) Pub. Date: Dec. 27, 2007

(54) Alumina composite sintered body, evaluation method thereof and spark plug

(75) Inventors: Itsuhei Ogata, Nishio-shi (JP); Yasuki Aoi, Gifu-city (JP); Hirofumi Suzuki, Kuwana-city (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); NIPPON SOKEN, INC., Nishio-shi (JP)

(21) Appl. No.: 11/812,563

(22) Filed: Jun. 20, 2007

(30) Foreign Application Priority Data
Jun. 23, 2006 (JP) 2006-173904

(51) Int. Cl. B32B 5/16

(52) U.S. Cl. 428/329; 428/328

(57) ABSTRACT

An alumina composite sintered body 1 in which fine particles 2 are dispersed in the crystal grains 4 and/or at the crystal grain boundaries 3 of an alumina sintered body obtained by sintering alumina crystal grains 4; an evaluation method thereof; and a spark plug using the alumina composite sintered body 1. Arbitrary regions in the cross-section of the alumina composite sintered body 1 are taken as analysis surfaces, and when the cross-sectional areas of the fine particles 2 contained in each analysis surface are measured, the ratio of the cross-sectional areas occupying in the area of the analysis surface is from 1 to 20%; when the cross-sectional areas of the fine particles 2 contained in each of analysis surfaces adjacent to each other are measured, and the cross-sectional area is converted into a circle having the same area, the diameter of the circle is from 0.1 to 4 μm; and when the concentration A (wt %) of the fine particles 2 contained in each analysis surface is compared with the concentration B (wt %) of the fine particles 2 used at the production, the difference between the concentration A and the concentration B is within ±20 wt %.

### TECHNICAL FIELD

The present invention relates to an alumina composite sintered body where fine particles are dispersed in an alumina sintered body obtained by sintering alumina crystal grains, an evaluation method thereof, and a spark plug using the alumina composite sintered body as an insulating material.

### BACKGROUND ART

An alumina sintered body comprising alumina as a main component is excellent in insulating and withstanding voltage. Therefore, an alumina insulating body has been used as an insulating material, for example, in a spark plug for the internal combustion engines of automobiles, engine components, IC substrates and the like.

A SiO₂—MgO—CaO type alumina sintered body comprising alumina (Al₂O₃) as a main component has been conventionally known as an alumina sintered body (see Japanese Patent No. 2564842).

This alumina sintered body is very stable both thermally and chemically and excellent in mechanical strength, and therefore has been widely used as an electrical insulating material of a spark plug for internal combustion engines or the like.

However, in such an alumina sintered body, a sintering assistant such as magnesium oxide (MgO), calcium oxide (CaO) and silicon oxide (SiO₂) is added during production so as to improve the sintering property, and this sintering assistant may form a liquid phase having a low melting point during sintering, to form a glass phase having low withstand voltage at the alumina grain boundary after sintering. Because of this, there is a limit to increasing the withstand voltage of the alumina sintered body.

In particular, along with the recent increasing of output of power or downsizing of engines, the area occupied by intake and exhaust valves in the combustion chamber of an internal combustion engine used for automobiles and the like has been increasing. Therefore, the spark plug for igniting an air-fuel mixture is also required to be downsized (reduced in diameter). In addition, it is necessary to reduce the thickness of an insulator intervening between a center electrode and a metal fitting in the spark plug. Thus, development of an alumina sintered body being more excellent in the withstand voltage property is in demand.

### SUMMARY OF INVENTIONS

The present invention has been made by taking into consideration these conventional problems, and an object of the present invention is to provide an alumina composite sintered body having excellent withstand voltage property, an evaluation method thereof, and a spark plug using such an alumina composite sintered body.

A first invention is an alumina composite sintered body comprising alumina as a main component,

wherein fine particles having a melting point of 1,300° C. or more, and comprising the primary particles having an average particle diameter of 200 nm or less and a maximum particle diameter of 1 μm or less, and/or the secondary particles resulting from aggregation of the primary particles are dispersed in crystal grains and/or at crystal grain boundaries of an alumina sintered body obtained by sintering alumina crystal grains comprising alumina, and

wherein, when an arbitrary region of 10 μm×10 μm in the cross-section of the alumina composite sintered body is taken as an analysis surface, and the cross-sectional areas of the fine particles contained in each of the analysis surfaces at least at 20 portions are measured, the ratio of the cross-sectional areas of the fine particles occupying in the area of the analysis surface is from 1% to 20%.

A second invention is an alumina composite sintered body comprising alumina as a main component,

wherein fine particles having a melting point of 1,300° C. or more, and comprising the primary particles having an average particle diameter of 200 nm or less and a maximum particle diameter of 1 μm or less, and/or the secondary particles resulting from aggregation of the primary particles are dispersed in crystal grains and/or at crystal grain boundaries of an alumina sintered body obtained by sintering alumina crystal grains comprising alumina, and

wherein, when an arbitrary region of 100 μm×100 μm in the cross-section of the alumina composite sintered body is taken as an analysis surface, the cross-sectional areas of the fine particles contained in each of the analysis surfaces at least at 20 portions adjacent to each other are measured, and each of the cross-sectional areas is converted into a circle having the same area, the diameter of the circle is from 0.1 μm to 4 μm.

A third invention is an alumina composite sintered body comprising alumina as a main component,

wherein fine particles having a melting point of 1,300° C. or more, and comprising the primary particles having an average particle diameter of 200 nm or less and a maximum particle diameter of 1 μm or less, and/or the secondary particles resulting from aggregation of the primary particles are dispersed in crystal grains and/or at crystal grain boundaries of an alumina sintered body obtained by sintering alumina crystal grains comprising alumina,

wherein the alumina composite sintered body has been formed by dispersing a powder of the fine particles and a powder of alumina particles at a predetermined blending ratio in a dispersion medium to prepare the raw material mixture slurry, and forming and firing the raw material mixture slurry, and

wherein, when an arbitrary region of 10 μm×10 μm in the cross-section of the alumina composite sintered body is taken as an analysis surface, and with respect to the analysis surfaces at least at 10 portions, the concentration A (wt %) of the fine particles contained in each of the analysis surfaces is compared with the concentration B (wt %) of the fine particles in a total amount of the alumina particles and the fine particles dispersed in the dispersion medium, the difference between the concentration A and the concentration B is within ±20 wt %.

In the first invention, a most notable feature is that the ratio of the cross-sectional areas of the fine particles occupying in the area of the analysis surface is from 1% to 20%. In the second invention, a most notable feature is that when the cross-sectional area of each fine particle contained in the analysis surface is measured and the measured cross-sectional area is converted into a circle having the same area, the diameter of the circle is from 0.1 μm to 4 μm. In the third invention, a most notable feature is that when the concentration A (wt %) of the fine particles contained in each analysis surface is compared with the concentration B (wt %) of the fine particles in a total amount of the alumina particles and the fine particles dispersed in the dispersion medium, the difference between the concentration A and the concentration B is within ±20 (wt %).

The alumina composite sintered body, in which, as in the first to third inventions, the ratio of the cross-sectional areas of the fine particles occupying in the area of the analysis surface (hereinafter sometimes referred to as “an area ratio of fine particles”), the diameter of the circle when the cross-sectional area of the fine particle is converted into a circle having the same area (hereinafter sometimes referred to as “an equivalent-circle diameter of a fine particle”), or the difference between the concentration A and the concentration B (hereinafter sometimes referred to as “a concentration difference of fine particles”) is in the above-described specific range, exhibits excellent withstand voltage property.

The reason why this alumina composite sintered body exhibits excellent withstand voltage property is not clearly known, but is considered to be because the particle having a melting point of 1,300° C. or more is dispersed in a state satisfying the above-describe area ratio, equivalent-circle diameter, or concentration difference of the fine particles, and therefore the grain growth of the alumina crystal grain during sintering the alumina crystal grain is suppressed, and as a result, the crystal grain boundary is increased. In other words, it is considered that the grain boundary resistance is increased and the withstand voltage property is enhanced.

In addition, the fine particles having a melting point as high as 1,300° C. or more can form a crystal phase together with the main component, alumina. Therefore, the insulating property thereof is high as compared with, for example, a glass phase composed of a conventional sintering assistance, and even when a high voltage is applied, it is difficult for the fine particles to form an electrically conducting path resulting from dielectric breakdown. Accordingly, in the above-described alumina composite sintered body, the electrically conducting path is disrupted, whereby the withstand voltage at the dielectric breakdown can be enhanced.

A fourth invention is a spark plug in which the alumina composite sintered body described above is used as an insulating material.

In this spark plug, the alumina composite sintered body of the first to third inventions having excellent withstand voltage property is used as an insulating material. Therefore, the spark plug exhibits excellent withstand voltage property.

A fifth invention is a spark plug comprising a metal fitting having a fitting screw part provided on an outer circumferential periphery thereof, an insulator fixed inside the metal fitting, a center electrode fixed inside the insulator so as for its distal end to protrude from the insulator, and a ground electrode fixed to the metal fitting to face the distal end of the center electrode through a spark discharge gap,

wherein the nominal diameter of the fitting screw part is M10 or less, and

the alumina composite sintered body described above is used as the insulator.

In this spark plug, the alumina composite sintered body of the first to third inventions having excellent withstand voltage property is used as the insulator. Therefore, even when the nominal diameter of the fitting screw part is reduced to M10 or less, the spark plug exhibits excellent withstand voltage property.

A sixth invention is an evaluation method for an alumina composite sintered body to be used as an insulating material of a spark plug, comprising using the alumina composite sintered body as an insulating material of the spark plug,

wherein the alumina composite sintered body comprises the alumina as a main component, in which fine particles having a melting point of 1,300° C. or more, and comprising the primary particles having an average particle diameter of 200 nm or less and a maximum particle diameter of 1 μm or less, and/or secondary particles resulting from aggregation of the primary particles are dispersed in crystal grains and/or at crystal grain boundaries of an alumina sintered body obtained by sintering alumina crystal grains comprising the alumina, and

wherein, when an arbitrary region of 10 μm×10 μm in the cross-section of the alumina composite sintered body is taken as an analysis surface, and the cross-sectional areas of the fine particles contained in each of the analysis surfaces at least at 20 portions are measured, the ratio of the cross-sectional areas of the fine particles occupying the area of the analysis surface is from 1% to 20%.

A seventh invention is an evaluation method for an alumina composite sintered body to be used as an insulating material of a spark plug, comprising using the alumina composite sintered body as the insulating material of the spark plug,

wherein the alumina composite sintered body comprises the alumina as a main component, in which fine particles having a melting point of 1,300° C. or more, and comprising the primary particles having an average particle diameter of 200 nm or less and a maximum particle diameter of 1 μm or less, and/or the secondary particles resulting from aggregation of the primary particles are dispersed in crystal grains and/or at crystal grain boundaries of an alumina sintered body obtained by sintering alumina crystal grains comprising the alumina, and

wherein, when an arbitrary region of 100 μm×100 μm in the cross-section of the alumina composite sintered body is taken as an analysis surface, the cross-sectional areas of the fine particles contained in each of the analysis surfaces at least at 20 portions adjacent to each other are measured, and each of the cross-sectional areas is converted into a circle having the same area, the diameter of the circle is from 0.1 μm to 4 μm.

An eighth invention is an evaluation method for an alumina composite sintered body to be used as an insulating material of a spark plug, comprising using the alumina composite sintered body as the insulating material of the spark plug,

wherein the alumina composite sintered body comprises alumina as a main component, in which fine particles having a melting point of 1,300° C. or more, and comprising the primary particles having an average particle diameter of 200 nm or less and a maximum particle diameter of 1 μm or less, and/or the secondary particles resulting from aggregation of the primary particles are dispersed in crystal grains and/or at crystal grain boundaries of an alumina sintered body obtained by sintering alumina crystal grains comprising the alumina,

wherein the alumina composite sintered body has been formed by dispersing a powder of the fine particles and a powder of alumina particles at a predetermined blending ratio in a dispersion medium to prepare the raw material mixture slurry, and forming and firing the raw material mixture slurry, and

wherein, when an arbitrary region of 10 μm×10 μm in the cross-section of the alumina composite sintered body is taken as an analysis surface, and with respect to the analysis surfaces at least at 10 portions, the concentration A (wt %) of the fine particles contained in each of the analysis surfaces is compared with the concentration B (wt %) of the fine particles in a total amount of the alumina particles and the fine particles dispersed in the dispersion medium, the difference between the concentration A and the concentration B is within ±20 wt %.

In the sixth invention, a most notable feature is that the alumina composite sintered body, in which the cross-sectional areas of the fine particles occupying in the area of the analysis surface is from 1% to 20%, is used as an insulating material of the spark plug. In the seventh invention, a most notable feature is that the alumina composite sintered body, in which, when the cross-sectional area of each fine particle contained in the analysis surface is measured and the measured cross-sectional area is converted into a circle having the same area, the diameter of the circle is from 0.1 μm to 4 μm, is used as an insulating material of the spark plug. In the eighth invention, a most notable feature is that the alumina composite sintered body, in which the difference between the concentration A and the concentration B is within ±20 wt %, is used as the insulating material.

As described above, the alumina composite sintered body, in which the ratio of the cross-sectional areas of the fine particles occupying in the area of the analysis surface (the area ratio of the fine particles), the diameter of the circle (the equivalent-circle diameter of the fine particle) when the cross-sectional area of the fine particle is converted into a circle having the same area, or the difference between the concentration A and the concentration B (the concentration difference of the fine particles) is in the above-described specific range, exhibits excellent withstand voltage property. Accordingly, as in the sixth to eighth inventions, when the alumina composite sintered body is selected by using the area ratio, equivalent-circle diameter or concentration difference of the fine particles as an index, the alumina composite sintered body suitable as the insulating material of the spark plug can be obtained. In addition, the alumina composite sintered body has excellent withstand voltage property and therefore, when used as the insulating material of the spark plug, the spark plug can be downsized.

### BRIEF DESCRIPTION OF THE DRAWINGS

FIG. 1 is an explanatory view schematically illustrating the crystal structure of the alumina composite sintered body in which the fine particles are dispersed at the alumina crystal grain boundary.

FIG. 2 is an explanatory view schematically illustrating the crystal structure of the alumina composite sintered body in which the fine particles are dispersed in the alumina crystal grains.

FIG. 3 is an explanatory view schematically illustrating the crystal structure of the alumina composite sintered body, in which the fine particles are dispersed in the alumina crystal grains and at the crystal grain boundaries.

FIG. 4 is a half-sectional view illustrating the entire structure of a spark plug.

### DETAILED DESCRIPTION

Preferred embodiments of the present invention will now be described below.

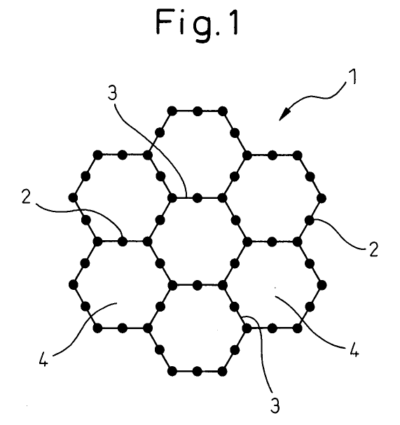

Each of FIGS. 1 to 3 shows an example of the crystal structure of the alumina composite sintered body.

As shown in the Figures, in the alumina composite sintered body 1, alumina crystal grains 4 are sintered and fine particles 2 having a melting point of 1,300° C. or more are dispersed in the crystal grains and/or at the crystal grain boundaries.

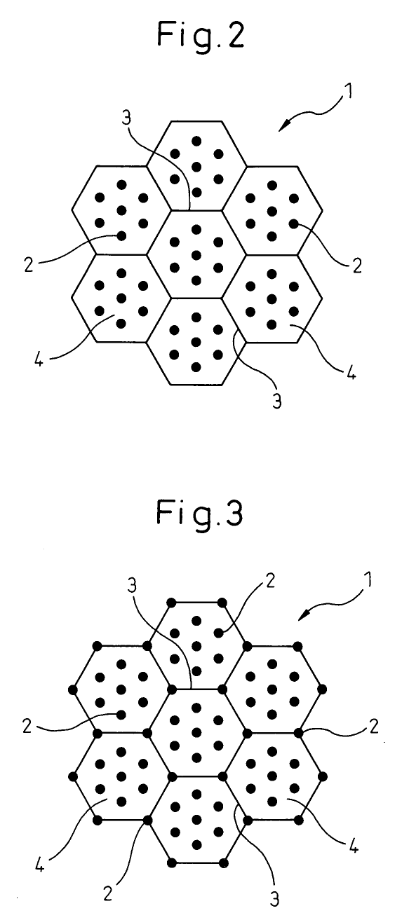

As shown in FIG. 1, in the alumina composite sintered body 1, the fine particles 2 can take the form of being dispersed at the grain boundaries 3 of the alumina crystal grains 4. In addition, as shown in FIG. 2, the fine particles 2 can take the form of being dispersed inside the alumina crystal grains 4. Furthermore, as shown in FIG. 3, the fine particles 2 can take the form of being dispersed at the grain boundaries 3 between the alumina crystal grains 4 and inside the alumina crystal grains 4.

As shown in FIGS. 1 to 3, the grain boundary 3 means an interface between alumina crystal grains 4, i.e. a region formed between two alumina crystal grains 4, and sometimes indicates a region formed among three alumina crystal grains 4 (so-called triple point). More specifically, when, in the cross-section of the alumina composite sintered body 1, a crystallographically distinct boundary is observed between crystal grains 4, and an interface aligned according to the crystal orientation and differing in the crystal arrangement is observed, this is defined as the grain boundary.

The above-described fine particles comprise the primary particles having an average particle diameter of 200 nm or less and a maximum particle diameter of 1 μm or less, and/or the secondary particles resulting from aggregation of the primary particles.

If the average primary particle diameter of the fine particles exceeds 200 nm, the fine particles may form an aggregate with each other and fail to disperse, as a result, the property may be degraded. On the other hand, if the maximum primary particle diameter exceeds 1 μm, the fine particles with a diameter exceeding 1 μm may serve each as a core to form an aggregate of several μm or more and fail to disperse, as a result, the property may be degraded.

The average particle diameter of the fine particles can be obtained by measuring the particle diameters of, for example, 100 arbitrary fine particles observed by a transmission electron microscope (TEM), and calculating its average value. When the fine particles are spherical, the particle diameter of the fine particles is the diameter of the particle. In the case where the fine particle is not spherical, the projected area of the fine particle is measured by image-processing, and the equivalent-circle diameter obtained by converting the projected area into the equivalent-circle area can be used as the particle diameter.

The maximum diameter of the fine particles is a maximum value of the particle diameter when the particle diameters are measured in the same manner as the average particle diameter.

The above-described fine particle has a melting point of 1,300° C. or more.

If the melting point of the fine particle is less than 1,300° C., the main component alumina melts at a sintering temperature of 1,300° C. or more, and forms a glass phase. As a result, the original effect resulting from addition of the fine particles may not be obtained, and thus the property may be degraded.

The alumina composite sintered body satisfies at least any one of the following conditions (A) to (C):

(A) when an arbitrary region with an area of 10 μm×10 μm in the cross-section of the alumina composite sintered body is taken as an analysis surface, and with respect to the analysis surfaces at least at 20 portions, the cross-sectional areas of the fine particles contained in each analysis surface are measured, the ratio of the cross-sectional areas of the fine particles occupying in the area of the analysis surface is from 1% to 20%,

(B) when an arbitrary region with an area of 100 μm×100 μm in the cross-section of the alumina composite sintered body is taken as an analysis surface, and with respect to the analysis surfaces at least at 20 portions adjacent to each other, the cross-sectional areas of the fine particles contained in each analysis surface are measured, and each of the measured cross-sectional areas is converted into a circle having the same area, the diameter of the circle is from 0.1 μm to 4 μm, and

(C) when an arbitrary region with an area of 10 μm×10 μm in the cross-section of the alumina composite sintered body is taken as an analysis surface, and with respect to the analysis surfaces at least at 10 portions, the concentration A (wt %) of the fine particles contained in each analysis surface is compared with the concentration B (wt %) of the fine particles in a total amount of the alumina particles and the fine particles dispersed in the dispersion medium, the difference between the concentration A and the concentration B is within ±20 wt %.

If the alumina composite sintered body does not satisfy any of above conditions (A) to (C), the withstand voltage property of the alumina composite sintered body may decrease. In addition, when such an alumina composite sintered body is used for an insulating material of a spark plug, the withstand voltage property is insufficient, and the spark plug may be difficult to downsize.

The measurement of the cross-sectional areas of the fine particles at the analysis surface can be performed as follows. Mapping analysis of the analysis surface is performed by an energy dispersion X-ray spectroscopy using a field effect-scanning transmission electron microscope to detect the cross-sectional areas of the fine particles contained in the analysis surface as a mapping dot image, and the areas of the dots in the mapping dot image are measured.

In addition, the measurement of the cross-sectional areas of the fine particles at the analysis surface can be performed as follows. Mapping analysis of the analysis surface is performed by an electron energy loss spectroscopy using an energy filter transmission electron microscope to detect the cross-sectional areas of the fine particles contained in the analysis surface as a mapping dot image, and the areas of the dots in the mapping dot image are measured.

Furthermore, the measurement of the cross-sectional areas of the fine particles at the analysis surface can be performed as follows. Mapping analysis of the analysis surface is performed by a high-angle annular dark-field method using a field effect-scanning transmission electron microscope to detect the cross-sectional areas of the fine particles contained in the analysis surface as a mapping dot image, and the areas of the dots in the mapping dot image are measured.

As described above, according to the energy dispersion X-ray spectroscopy (EDS) using a field effect-scanning transmission electron microscope (FE-STEM), the electron energy loss spectroscopy (EELS) using an energy filter transmission electron microscope (EFTEM), or the high-angle annular dark-field method using a field effect-scanning transmission electron microscope (FE-STEM), the element such as metal element constituting the fine particles at the analysis surface can be detected. Therefore, when mapping analysis is performed, the dispersed state of the fine particles can be detected, for example, as colored dots in the mapping dot image, so that the cross-sectional areas of the fine particles in the analysis surface can be easily and accurately measured.

The concentration A of the fine particles contained in the analysis surface can be measured by performing the mapping analysis by an energy dispersion X-ray spectroscopy using a field effect-scanning transmission electron microscope with respect to the region after 10,000-fold enlargement of the analysis surface.

In addition, the concentration A of the fine particles contained in the analysis surface can be measured by performing the mapping analysis by an electron energy loss spectroscopy using an energy filter transmission electron microscope with respect to the region after 10,000-fold enlargement of the analysis surface.

Furthermore, the concentration A of the fine particles contained in the analysis surface can be measured by performing the mapping analysis by a high-angle annular dark-field method using a field effect-scanning transmission electron microscope with respect to the region after 10,000-fold enlargement of the analysis surface.

According to the energy dispersion X-ray spectroscopy using a field effect-scanning transmission electron microscope, the electron energy loss spectroscopy using an energy filter transmission electron microscope, or the high-angle annular dark-field method using a field effect-scanning transmission electron microscope, an element such as a metal element constituting the fine particle can be detected and the concentration thereof can be measured. The concentration of the fine particles can be calculated from the measured element concentration. More specifically, the concentration (concentration A) of the fine particles can be calculated from the element concentration. In this case, at the time of calculating the difference between the concentration A and the concentration B, as regards the concentration (concentration B) of the fine particles in a total amount of the alumina particles and the fine particles dispersed in the dispersion medium, the concentration (concentration B) is also calculated based on the molecular weight of the compound constituting the fine particle.

The element concentration measured above can also be used directly as the concentration (concentration A) of the fine particles. In this case, at the time of calculating the difference between the concentration A and the concentration B, the concentration (concentration B) of the fine particles in a total amount of the alumina particles and the fine particles dispersed in the dispersion medium is also converted into the concentration of the element such as metal element constituting the fine particles.

The fine particle preferably comprises one or more species selected from Al₂O₃, SiO₂, MgO, Y₂O₃, ZrO₂, Sc₂O₃, TiO₂, Cr₂O₃, Mn₂O₃, MnO, Fe₂O₃, NiO, CuO, ZnO, Ga₂O₃, Nb₂O₅, La₂O₃, CeO₂, Pr₂O₃, Pr₆O₁₁, Nd₂O₃, Pm₂O₃, Sm₂O₃, Eu₂O₃, Gd₂O₃, Tb₂O₃, Dy₂O₃, Ho₂O₃, Er₂O₃, Tm₂O₃, Yb₂O₃, Lu₂O₃, HfO₂, Ta₂O₅, WO₃, MgAl₂O₄, Al₂SiO₅, 3Al₂O₃.2SiO₂, YAlO₃, Y₃Al₅O₁₂, LaAlO₃, CeAlO₃, NdAlO₃, PrAlO₃, SmAlO₃, EuAlO₃, GdAlO₃, TbAlO₃, DyAlO₃, HoAlO₃, YbAlO₃, LuAlO₃, Y₂SiO₅, ZrSiO₄, CaSiO₃, 2MgO.SiO₂, MgO.SiO₂, MgSiO₃ and MgCr₂O₄.

In this case, in the alumina composite sintered body, the fine particles can form an oxide layer having the excellent insulating property at the grain boundaries of the alumina crystal grains. Therefore, the withstand voltage property of the alumina composite sintered body can be more enhanced.

The alumina composite sintered body preferably contains the fine particles in an amount of 0.05% to 5 wt %.

In the case of the fine particle content is less than 0.05 wt %, the fine particles may not contribute to the property enhancement, whereas if the content exceeds 5 wt %, the fine particles may form an aggregate with each other and fail to disperse. As a result, the property of the alumina composite sintered body may be degraded.

The alumina composite sintered body preferably contains an Si element-containing an Si compound as a sintering assistant.

In this case, the denseness of the alumina composite sintered body can be more enhanced.

The above-described alumina composite sintered body can be produced by dispersing a powder of the fine particles and a powder of alumina particles at a predetermined blending ratio in a dispersion medium to prepare a raw material mixture slurry, and the raw material mixture slurry was dried by spray drying and granulating to obtain a granulated powder. The granulated powder was compacted into an insulator shape to obtain a powder compact, and the compact then fired to obtain an alumina composite sintered body having an insulator shape.

The area ratio, equivalent-circle diameter and concentration difference of the fine particles can be controlled by adjusting, for example, the blending ratio between the fine particle powder and the alumina particle powder, the dispersion method of the raw material mixture, the firing temperature and the like.

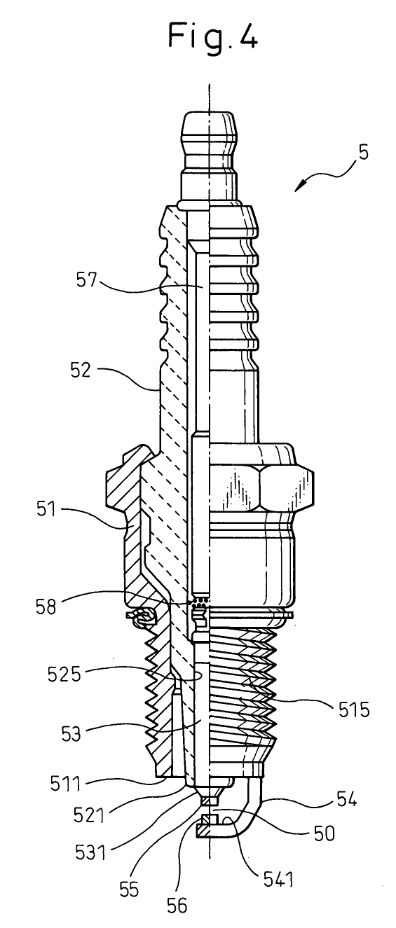

The spark plug will be described below. FIG. 4 shows one example of the spark plug.

As shown in the Figure, the spark plug 5 is used as an ignition plug or the like of an automobile engine, and is fixed in place by being inserted into a screw hole provided in an engine head (not shown) defining a combustion chamber of the engine.

The spark plug 5 has an electrically conductive cylindrical metal fitting 51 which comprises, for example, a steel material such as low-carbon steel. On the outer circumferential periphery of the metal fitting 51, a fitting screw part 515 for fixing it into an engine block (not shown) is provided. In this embodiment, the nominal diameter of the fitting screw part 515 is 10 mm or less, and the fitting screw part 515 has a value of M10 or less under the JIS (Japanese Industrial Standard).

An insulator 52 is housed and fixed inside the metal fitting 51. In this embodiment, the insulator 52 comprises the above-described alumina composite sintered body. The distal end 521 of the insulator 52 protrudes from the distal end 511 of the metal fitting 51.

A center electrode 53 is fixed in an axial hole 525 of the insulator 52, whereby the center electrode 53 is electrically insulated from the metal fitting 51.

The center electrode 53 comprises a cylindrical body the inner member of which is made of a metal material having excellent thermal conductivity, such as Cu, and the outer member is made of a metal material having excellent heat resistance and corrosion resistance, such as a Ni-based alloy.

As shown in FIG. 4, the center electrode 53 is disposed so that its distal end 531 protrudes from the distal end 521 of the insulator 52. In this manner, the center electrode 53 is housed in the metal fitting 51 while its distal end 531 protrudes.

On the other hand, the ground electrode 54 has a columnar shape, and is made of, for example, a Ni-based alloy comprising Ni as a main component. In this embodiment, the ground electrode 54 has a rectangular column shape, is fixed at its one end to the distal end 511 of the metal fitting 51 by welding or the like, and is bent in a nearly L-shaped configuration at its intermediate portion to oppose, at the side surface 541 on the other end side, the distal end 531 of the center electrode 53 through a spark discharge gap 50.

Here, a noble metal chip 55 is provided on the distal end 531 of the center electrode 53 to protrude from the distal end 531. In addition, a noble metal chip 56 is provided on the side surface 541 of the ground electrode 54 to protrude from the side surface 541.

The noble metal chips 55 and 56 are formed of an Ir (iridium) alloy, a Pt (platinum) alloy or the like, and are joined to the electrode base materials 53 and 54, for example, by laser-welding or resistance-welding.

The spark discharge gap 50 is a clearance between the distal ends of the two noble metal chips 55 and 56. The size of the spark discharge gap 50 may be, for example, about 1 mm.

On the site opposite the distal end 521 of the insulator 52, a stem 57 for pulling the center electrode 53 out is provided in the axial hole 525 of the insulator 52. The stem 57 has electrical conductivity and is rod-shaped, and in the inside of the axial hole 525 of the insulator 52, the stem is electrically connected to the center electrode 53 through an electrically conductive glass seal 58.

### EXAMPLES

The present inventions will now be described below by referring to the Examples.

### Example 1

In this Example, an alumina composite sintered body is produced, and a withstand voltage property thereof is then evaluated.

First, an alumina composite sintered body is produced, in which fine particles comprising Y₂O₃ are dispersed in the crystal grains and/or at the crystal grain boundaries of an alumina sintered body obtained by sintering alumina crystal grains comprising the alumina. In this Example, 10 kinds of alumina composite sintered bodies (Samples X2 to X11) are produced, in which, when arbitrary regions with an area of 10 μm×10 μm in the cross-section of the alumina composite sintered body are taken as analysis surfaces at least at 20 portions, and the cross-sectional areas of the fine particles contained in each analysis surface are measured, the ratios of the cross-sectional areas of the fine particles occupying the areas of the analysis surfaces (the area ratio of the fine particles) are different from each other.

More specifically, an alumina particle powder having an average particle diameter of 0.4 μm to 1.0 μm and comprising the alumina having a purity of 99.9% or more was prepared. In addition, a sintering assistant comprising SiO₂ (silicon oxide) was prepared. Furthermore, fine particles having an average particle diameter of 100 nm and comprising Y₂O₃ were prepared. The average particle diameter of the fine particles is an arithmetic average particle diameter of 100 particles observed by a transmission electron microscope (TEM). The maximum diameter of these fine particles was less than 1 μm.

Subsequently, 100 parts by weight of the alumina particle powder, 2 parts by weight of the sintering assistant and 0.2 parts by weight of the fine particles were dispersed in water to produce the raw material mixture slurry.

More specifically, 100 parts by weight of pure water were added to a mixing tank equipped with a stirring blade, and 2 parts by weight of the sintering assistant and 0.2 parts by weight of the fine particles were further added. These were then mixed and dispersed by the stirring blade. At this time, the pH value (hydrogen ion concentration) of the liquid dispersion was adjusted to be from 8 to 10. By this adjustment, the surface potential (zeta potential) of the particle can be controlled so as to allow the particles of the sintering assistant and the fine particles to repel each other and not to cause aggregation. Incidentally, the surface potential can be freely set by selecting the pH value of the liquid dispersion.

The mixing tank has ultrasonic vibration means which functions to prevent aggregation of the sintering assistant particles and the fine particles in the liquid dispersion.

Thereafter, 100 parts by weight of the alumina particle powder and an appropriate amount of a binder were added to the liquid dispersion in the mixing tank, and mixed with stirring for 30 minutes or more to prepare the raw material mixture slurry. As for the binder, for example, a resin material such as polyvinyl alcohol and an acryl may be used. Furthermore, this raw material mixture slurry was mixed and dispersed in a high-speed rotor mixer.

The high-speed rotor mixer has a mixing area and a plurality of high-speed rotors each revolving at a circumferential velocity of 20 m/sec or more in the mixing area. When the raw material mixture slurry is introduced into the mixing area with the rotors rotating at high speed, a high-speed swirling flow of the raw material mixture slurry is formed. Further, when the raw material mixture slurry passes through a gap of about 1 mm formed between respective rotors, a shock wave is generated, and aggregation of the sintering assistant and the fine particles in the raw material mixture slurry is suppressed by virtue of this shock wave. As a result, a mixed raw material slurry is obtained, in which the alumina particles, sintering assistant particles and the fine particles are uniformly dispersed.

Incidentally, the operation of the high-speed rotor mixer was a three-pass operation. One-pass means that the entire amount of the raw material mixture slurry passes through the mixing room of the high-speed rotor mixer at one time, and three-pass means that the mixture passes three times.

In the raw material mixture slurry obtained as described above, respective particles are more uniformly dispersed than in slurry obtained, for example, by a conventional mixing/dispersing method using solid media (e.g., zirconia beads), such as a medium stirring mill. In the conventional mixing/dispersing method, when a pulverizing force is applied to the alumina particles, the surface potential (zeta potential) on the alumina surface is changed, or an active surface is produced on the particle surface, and therefore the sintering assistant particles and fine particles are adsorbed to the alumina particle surfaces by a suction force such as mechanochemical force. As a result, an aggregate is readily formed.

Next, the raw material mixture slurry obtained above was dried by spray drying and granulating to obtain a granulated powder. The granulated powder was compacted into an insulator shape to obtain a powder compact, and the compact then fired to obtain an alumina composite sintered body having an insulator shape. In this Example, 10 kinds of alumina composite sintered bodies (Samples X2 to X11) were prepared by changing the firing conditions (temperature and time) during firing in the range wherein the firing temperature was from 1,300° C. to 1,600° C. and the firing time was from 1 hour to 3 hours. Samples X2 to X11 all contain fine particles comprising Y₂O₃.

In this Example, an alumina sintered body (Sample X1) obtained by sintering alumina crystal grains comprising alumina was also prepared for comparison. Sample X1, which does not contain the fine particles, was prepared in the same manner as Sample X2, except for not using the fine particles.

The withstand voltage of each alumina composite sintered body of Samples X1 to X11 was measured using a withstand voltage measuring device.

More specifically, an internal electrode of the withstand voltage measuring device was inserted into the alumina composite sintered body having an insulator shape. In addition, a circular ring-like external electrode was engaged on the outer circumference of the alumina composite sintered body, and disposed so as to maintain the measuring point at a position where the alumina sintered body thickness is 1.0±0.05 mm.

Subsequently, a high voltage generated by a constant voltage source via an oscillator and a coil was applied between the internal electrode and the external electrode. At this time, the voltage was raised in 1 kV/sec steps at a frequency of 30 cycles/sec, while monitoring by an oscilloscope. The voltage was measured when dielectric breakdown of the alumina composite sintered body occurred, and the measured voltage was used as the withstand voltage. The results are shown in Table 1.

Thereafter, using Samples X1 to X11, arbitrary regions with the area of 10 μm×10 μm in the cross-section of each Sample were taken as analysis surfaces at least at 20 portions, and the cross-sectional area of each of the fine particles contained in each analysis surface was measured. More specifically, the cross-sectional area of each fine particle contained in each analysis surface was detected as a mapping dot image (color dot image) by performing mapping analysis according to energy dispersion X-ray spectroscopy (EDS) using a field effect-scanning transmission electron microscope (FE-STEM). In the analysis, elemental analysis was performed based on the characteristic X-rays generated by each sample by using a field effect-scanning transmission electron microscope and an energy dispersion X-ray spectroscopy analyzer. By this analysis, a single particle (a primary particle) or aggregated particles (a secondary particle) of the fine particles in each analysis surfaces at 20 portions was observed and discriminated as a mapping dot image (color dot image). The mapping dot image of the single particle or the aggregated particles of the fine particles was defined as a fine particle region, and then the area ratio of the fine particle regions occupying in the analysis surface was detected. The results are shown in Table 1.

In addition, in this Example, 80 kinds of alumina composite sintered bodies (Samples X12 to X91) were prepared using the fine particles each having a composition different from those of Samples X2 to X11.

In other words, Samples X12 to X21 were prepared according to the same production method as Samples X2 to X11, except for using the fine particles comprising MgO. In addition, Samples X12 to X21 were prepared by changing the firing conditions (temperature and time). The firing temperature was changed in the range from 1,300° C. to 1,600° C., and the firing time was changed in the range from 1 hour to 3 hours.

Samples X22 to X31 were prepared according to the same production method as Samples X2 to X11, except for using the fine particles comprising SiO₂. In addition, Samples X22 to X31 were prepared by changing the firing conditions (temperature and time). The firing temperature was changed in the range from 1,300° C. to 1,600° C., and the firing time was changed in the range from 1 hour to 3 hours.

Samples X32 to X41 were prepared according to the same production method as Samples X2 to X11, except for using the fine particles comprising ZrO₂. In addition, Samples X32 to X41 were prepared by changing the firing conditions (temperature and time). The firing temperature was changed in the range from 1,300° C. to 1,600° C., and the firing time was changed in the range from 1 hour to 3 hours.

Samples X42 to X51 were prepared according to the same production method as Samples X2 to X11, except for using the fine particles comprising Lu₂O₃. In addition, Samples X42 to X51 were prepared by changing the firing conditions (temperature and time). The firing temperature was changed in the range from 1,300° C. to 1,600° C., and the firing time was changed in the range from 1 hour to 3 hours.

Samples X52 to X61 were prepared according to the same production method as Samples X2 to X11, except for using the fine particles comprising NdAlO₃. In addition, Samples X52 to X61 were prepared by changing the firing conditions (temperature and time). The firing temperature was changed in the range from 1,300° C. to 1,600° C., and the firing time was changed in the range from 1 hour to 3 hours.

Samples X62 to X71 were prepared according to the same production method as Samples X2 to X11, except for using the fine particles comprising ZrSiO₄. In addition, Samples X62 to X71 were prepared by changing the firing conditions (temperature and time). The firing temperature was changed in the range from 1,300° C. to 1,600° C., and the firing time was changed in the range from 1 hour to 3 hours.

Samples X72 to X81 were prepared according to the same production method as Samples X2 to X11, except for using the fine particles comprising Nb₂O₅. In addition, Samples X72 to X81 were prepared by changing the firing conditions (temperature and time). The firing temperature was changed in the range from 1,300° C. to 1,600° C., and the firing time was changed in the range from 1 hour to 3 hours.

Samples X82 to X91 were prepared according to the same production method as Samples X2 to X11, except for using the fine particles comprising Nd₂O₃. In addition, Samples X82 to X91 were prepared by changing the firing conditions (temperature and time). The firing temperature was changed in the range from 1,300° C. to 1,600° C., and the firing time was changed in the range from 1 hour to 3 hours.

The withstand voltages and the area ratios of the fine particles of Samples X12 to X91 were also measured in the same manner as Samples X1 to X11. The results are shown in Tables 1 to 3.

The area ratios of the fine particles of Samples X1 to X91 was measured also by the following electron energy loss spectroscopy (EELS) using an energy filter transmission electron microscope (EFTEM).

More specifically, using Samples X1 to X91, arbitrary regions with the area of 10 μm×10 μm in the cross-section of each Sample were taken as analysis surfaces at least at 20 portions, and the cross-sectional areas of the fine particles contained in each analysis surface were detected as the mapping dot image (color dot image), by performing mapping analysis according to the electron energy loss spectroscopy using an energy filter transmission electron microscope. In the analysis, elemental analysis was performed based on the characteristic X-rays generated from each sample by using EFTEM and EELS analyzer. By this analysis, a single particle (a primary particle) or aggregated particles (a secondary particle) of the fine particles in each analysis surface at 20 portions was observed and discriminated as the mapping dot image (color dot image). The mapping dot image of the single particle or the aggregated particles of the fine particles was defined as a fine particle region, and then the area ratio of the fine particle regions occupying in the analysis surface was detected.

As a result, the same results as the results by the above-described energy dispersion X-ray spectroscopy (EDS) using a field effect-scanning transmission electron microscope (FE-STEM) (see Tables 1 to 3) were obtained.

The area ratios of the fine particles of Samples X1 to X91 were measured also by the following high-angle annular dark-field method (HAADF) using a field effect-scanning transmission electron microscope (FE-STEM).

More specifically, using Samples X1 to X91, arbitrary regions with the area of 10 μm×10 μm in the cross-section of each Sample were taken as analysis surfaces at least at 20 portions, and the cross-sectional areas of the fine particles contained in each analysis surface were detected as a mapping dot image (color dot image), by performing mapping analysis according to the high-angle annular dark-field method (HAADF) using a field effect-scanning transmission electron microscope (FE-STEM). In the analysis, elemental analysis was performed based on the characteristic X-rays generated from each sample by using FE-STEM and HAADF analyzer. By this analysis, a single particle (a primary particle) or aggregated particles (a secondary particle) of the fine particles in each analysis surface at 20 portions was observed and discriminated as a mapping dot image (color dot image). The mapping dot image of the single particle or the aggregated particles of the fine particles was defined as a fine particle region, and then the area ratio of the fine particle regions occupying in the analysis surface was detected.

As a result, the same results as the results by the above-described energy dispersion X-ray spectroscopy (EDS) using a field effect-scanning transmission electron microscope (FE-STEM) (see, Tables 1 to 3) were obtained.

TABLE 1

| Sample | Composition of | Area Ratio of Fine | Withstand |
|---|---|---|---|
| No. | Fine Particle | Particles (%) | Voltage (kV) |
| X1 | — | 0 | 29 |
| X2 | Y₂O₃ | 1 | 32 |
| X3 | Y₂O₃ | 2 | 37 |
| X4 | Y₂O₃ | 3 | 40 |
| X5 | Y₂O₃ | 5 | 41 |
| X6 | Y₂O₃ | 10 | 42 |
| X7 | Y₂O₃ | 15 | 41 |
| X8 | Y₂O₃ | 20 | 38 |
| X9 | Y₂O₃ | 30 | 29 |
| X10 | Y₂O₃ | 40 | 20 |
| X11 | Y₂O₃ | 50 | 19 |
| X12 | MgO | 1 | 32 |
| X13 | MgO | 2 | 37 |
| X14 | MgO | 3 | 40 |
| X15 | MgO | 5 | 41 |
| X16 | MgO | 10 | 42 |
| X17 | MgO | 15 | 40 |
| X18 | MgO | 20 | 38 |
| X19 | MgO | 30 | 29 |
| X20 | MgO | 40 | 20 |
| X21 | MgO | 50 | 19 |
| X22 | SiO₂ | 1 | 32 |
| X23 | SiO₂ | 2 | 37 |
| X24 | SiO₂ | 3 | 39 |
| X25 | SiO₂ | 5 | 40 |
| X26 | SiO₂ | 10 | 41 |
| X27 | SiO₂ | 15 | 40 |
| X28 | SiO₂ | 20 | 38 |
| X29 | SiO₂ | 30 | 28 |
| X30 | SiO₂ | 40 | 20 |
| X31 | SiO₂ | 50 | 19 |

TABLE 2

| Sample | Composition of | Area Ratio of Fine | Withstand |
|---|---|---|---|
| No. | Fine Particle | Particles (%) | Voltage (kV) |
| X32 | ZrO₂ | 1 | 32 |
| X33 | ZrO₂ | 2 | 37 |
| X34 | ZrO₂ | 3 | 40 |
| X35 | ZrO₂ | 5 | 42 |
| X36 | ZrO₂ | 10 | 42 |
| X37 | ZrO₂ | 15 | 41 |
| X38 | ZrO₂ | 20 | 38 |
| X39 | ZrO₂ | 30 | 29 |
| X40 | ZrO₂ | 40 | 20 |
| X41 | ZrO₂ | 50 | 19 |
| X42 | Lu₂O₃ | 1 | 32 |
| X43 | Lu₂O₃ | 2 | 37 |
| X44 | Lu₂O₃ | 3 | 41 |
| X45 | Lu₂O₃ | 5 | 42 |
| X46 | Lu₂O₃ | 10 | 42 |
| X47 | Lu₂O₃ | 15 | 41 |
| X48 | Lu₂O₃ | 20 | 38 |
| X49 | Lu₂O₃ | 30 | 29 |
| X50 | Lu₂O₃ | 40 | 20 |
| X51 | Lu₂O₃ | 50 | 19 |
| X52 | NdAlO₃ | 1 | 32 |
| X53 | NdAlO₃ | 2 | 37 |
| X54 | NdAlO₃ | 3 | 41 |
| X55 | NdAlO₃ | 5 | 42 |
| X56 | NdAlO₃ | 10 | 42 |
| X57 | NdAlO₃ | 15 | 41 |
| X58 | NdAlO₃ | 20 | 38 |
| X59 | NdAlO₃ | 30 | 29 |
| X60 | NdAlO₃ | 40 | 20 |
| X61 | NdAlO₃ | 50 | 19 |

TABLE 3

| Sample | Composition of | Area Ratio of Fine | Withstand |
|---|---|---|---|
| No. | Fine Particle | Particles (%) | Voltage (kV) |
| X62 | ZrSiO₄ | 1 | 32 |
| X63 | ZrSiO₄ | 2 | 37 |
| X64 | ZrSiO₄ | 3 | 40 |
| X65 | ZrSiO₄ | 5 | 42 |
| X66 | ZrSiO₄ | 10 | 42 |
| X67 | ZrSiO₄ | 15 | 41 |
| X68 | ZrSiO₄ | 20 | 38 |
| X69 | ZrSiO₄ | 30 | 29 |
| X70 | ZrSiO₄ | 40 | 20 |
| X71 | ZrSiO₄ | 50 | 19 |
| X72 | Nb₂O₅ | 1 | 32 |
| X73 | Nb₂O₅ | 2 | 37 |
| X74 | Nb₂O₅ | 3 | 40 |
| X75 | Nb₂O₅ | 5 | 42 |
| X76 | Nb₂O₅ | 10 | 41 |
| X77 | Nb₂O₅ | 15 | 40 |
| X78 | Nb₂O₅ | 20 | 38 |
| X79 | Nb₂O₅ | 30 | 29 |
| X80 | Nb₂O₅ | 40 | 20 |
| X81 | Nb₂O₅ | 50 | 19 |
| X82 | Nd₂O₃ | 1 | 32 |
| X83 | Nd₂O₃ | 2 | 37 |
| X84 | Nd₂O₃ | 3 | 40 |
| X85 | Nd₂O₃ | 5 | 41 |
| X86 | Nd₂O₃ | 10 | 42 |
| X87 | Nd₂O₃ | 15 | 42 |
| X88 | Nd₂O₃ | 20 | 38 |
| X89 | Nd₂O₃ | 30 | 29 |
| X90 | Nd₂O₃ | 40 | 20 |
| X91 | Nd₂O₃ | 50 | 19 |

As can be seen from Tables 1 to 3, all of samples (Samples X2 to X8, Samples X12 to X18, Samples X22 to X28, Samples X33 to X38, Samples X42 to X48, Samples X52 to X58, Samples X62 to X68, Samples X72 to X78 and Samples X82 to X88), where the area ratio of the fine particles is from 1% to 20%, exhibited a high withstand voltage of 32 kV or more. The area ratio is more preferably from 2 to 20%, and in such a case, a withstand voltage as high as 37 kV or more can be exhibited. The alumina composite sintered body exhibiting such a high withstand voltage is suitable for an insulating material of a spark plug, and enables downsizing of the spark plug.

### Example 2

In this Example, a plurality of alumina composite sintered bodies are produced, in which when arbitrary regions with the area of 10 μm×10 μm in the cross-section of each alumina composite sintered body are taken as analysis surfaces at least at 10 portions, and the concentration A (wt %) of the fine particles contained in each analysis surface is compared with the amount (concentration B (wt %)) of the fine particles in a total amount of the alumina particles and the fine particles used at the production, the differences between the concentration A and the concentration B are different from each other.

In this Example, first, 11 kinds of alumina composite sintered bodies (Samples X92 to X102) containing the fine particles comprising Y₂O₃, and varying in the difference between the concentration A and the concentration B are prepared.

More specifically, similar to Example 1, an alumina particle powder having an average particle diameter of 0.4 to 1.0 μm and comprising alumina having a purity of 99.9% or more was prepared. In addition, a sintering assistant comprising SiO₂ (silicon oxide) was prepared. Furthermore, fine particles having an average particle diameter of 100 nm and comprising Y₂O₃ were prepared. The average particle diameter of the fine particles is an arithmetic average particle diameter of 100 particles observed by a transmission electron microscope (TEM). The maximum diameter of the fine particles was less than 1 μm.

Subsequently, 100 parts by weight of the alumina particle powder, 2 parts by weight of the sintering assistant and 0.2 parts by weight of the fine particles were dispersed in water to produce the raw material mixture slurry. The production of the raw material mixture slurry was performed by the same method as in Example 1.

The raw material mixture slurry obtained above was dried by spray drying and granulating to obtain a granulated powder. The granulated powder was compacted into an insulator shape to obtain a powder compact, and the compact then fired to obtain an alumina composite sintered body having an insulator shape. In this Example, 11 kinds of alumina composite sintered bodies were prepared by changing the firing temperature and firing time during firing, and were designated as Samples X92 to X102. The firing temperature was changed in the range from 1,300° C. to 1,600° C. and the firing time was changed in the range from 1 hour to 3 hours.

In addition, in this Example, 88 kinds of alumina composite sintered bodies (Samples X103 to X190) were prepared using the fine particles each having a composition different from those of Samples X92 to X102.

Specifically, Samples X103 to X113 were prepared according to the same production method as Samples X92 to X102, except for using the fine particles comprising MgO. In addition, Samples X103 to X113 were prepared by changing the firing conditions (temperature and time). The firing temperature was changed in the range from 1,300° C. to 1,600° C., and the firing time was changed in the range from 1 hour to 3 hours.

Samples X114 to X124 were prepared according to the same production method as Samples X92 to X102, except for using the fine particles comprising SiO₂. In addition, Samples X114 to X124 were prepared by changing the firing conditions (temperature and time). The firing temperature was changed in the range from 1,300° C. to 1,600° C., and the firing time was changed in the range from 1 hour to 3 hours.

Samples X125 to X135 were prepared according to the same production method as Samples X92 to X102, except for using the fine particles comprising ZrO₂. In addition, Samples X125 to X135 were prepared by changing the firing conditions (temperature and time). The firing temperature was changed in the range from 1,300° C. to 1,600° C., and the firing time was changed in the range from 1 hour to 3 hours.

Samples X136 to X146 were prepared according to the same production method as Samples X92 to X102, except for using the fine particles comprising Lu₂O₃. In addition, Samples X136 to X146 were prepared by changing the firing conditions (temperature and time). The firing temperature was changed in the range from 1,300° C. to 1,600° C., and the firing time was changed in the range from 1 hour to 3 hours.

Samples X147 to X157 were prepared according to the same production method as Samples X92 to X102, except for using the fine particles comprising NdAlO₃. In addition, Samples X147 to X157 were prepared by changing the firing conditions (temperature and time). The firing temperature was changed in the range from 1,300° C. to 1,600° C., and the firing time was changed in the range from 1 hour to 3 hours.

Samples X158 to X168 were prepared according to the same production method as Samples X92 to X102, except for using the fine particles comprising ZrSiO₄. In addition, Samples X158 to X168 were prepared by changing the firing conditions (temperature and time). The firing temperature was changed in the range from 1,300° C. to 1,600° C., and the firing time was changed in the range from 1 hour to 3 hours.

Samples X169 to X179 were prepared according to the same production method as Samples X92 to X102, except for using the fine particles comprising Nb₂O₅. In addition, Samples X169 to X179 were prepared by changing the firing conditions (temperature and time). The firing temperature was changed in the range from 1,300° C. to 1,600° C., and the firing time was changed in the range from 1 hour to 3 hours.

Samples X180 to X190 were prepared according to the same production method as Samples X92 to X102, except for using the fine particles comprising Nd₂O₃. In addition, Samples X180 to X190 were prepared by changing the firing conditions (temperature and time). The firing temperature was changed in the range from 1,300° C. to 1,600° C., and the firing time was changed in the range from 1 hour to 3 hours.

The withstand voltage of each of Samples X92 to X190 produced in this Example was measured in the same manner as in Example 1. The results are shown in Tables 4 to 6. In Table 4, the result of withstand voltage of Sample X1 not containing the fine particles (see Example 1) is shown together for comparison.

Using each sample (Samples X92 to X190), the difference between the concentration A and the concentration B (concentration difference of fine particles) was measured as follows.

Arbitrary regions with the area of 10 μm×10 μm in the cross-section of the alumina composite sintered body of each sample were taken as analysis surfaces at least at 10 portions, the concentration A (wt %) of the fine particles contained in each analysis surface was measured. The concentration A of the fine particles contained in each analysis surface was measured by performing mapping analysis according to the energy dispersion X-ray spectroscopy (EDS) using a field effect-scanning transmission electron microscope (FE-STEM) with respect to the 10 μm×10 μm region after 10,000-fold enlargement of the analysis surface.

By this analysis, an element such as a metal element constituting the fine particles at the analysis surface can be detected and the element concentration can be measured. In this Example, the element concentration was used as the concentration A.

The concentration B is the concentration of the fine particles in a total amount of the alumina particles and the fine particles dispersed in the dispersion medium at the production of the alumina composite sintered body. However, in this Example, this concentration was converted into the concentration of the element (the element detected by the mapping analysis) constituting the fine particles dispersed in the dispersion medium, and was used as the concentration B. Also, the concentration difference (concentration A−concentration B) of each sample was calculated. The results are shown in Tables 4 to 6.

The concentration differences of Samples X92 to X190 were measured also by the following electron energy loss spectroscopy (EELS) using an energy filter transmission electron microscope (EFTEM).

More specifically, using each sample, arbitrary regions with the area of 10 μm×10 μm were taken as analysis surfaces at least at 10 portions, and the concentration difference was measured at each analysis surface by performing mapping analysis according to the electron energy loss spectroscopy using an energy filter transmission electron microscope. In the analysis, the elemental analysis was performed based on the characteristic X-rays generated from each sample by using the EFTEM and EELS analyzers. By this analysis, an element such as a metal element constituting the fine particles at the analysis surface was detected and the element concentration (concentration A) was measured. The concentration of the fine particles in a total amount of the alumina particles and the fine particles dispersed in the dispersion medium was converted into the concentration of the element constituting the fine particles, and was used as the concentration B, and the concentration difference (concentration A−concentration B) of each sample was calculated.

As a result, the same results (see Tables 4 to 6) as those obtained by the above-described energy dispersion X-ray spectroscopy (EDS) using a field effect-scanning transmission electron microscope (FE-STEM) were obtained.

The concentration differences of Samples X92 to X190 were measured also by the following high-angle annular dark-field method (HAADF) using a field effect-scanning transmission electron microscope (FE-STEM).

More specifically, using each sample, arbitrary regions with the area of 10 μm×10 μm were taken as analysis surfaces at least at 10 portions, and the concentration difference was measured at each analysis surface by performing mapping analysis according to the high-angle annular dark-field method using a field effect-scanning transmission electron microscope. In the analysis, the elemental analysis was performed based on the characteristic X-rays generated from each sample by using the FE-STEM and HAADF analyzers. By this analysis, an element such as a metal element constituting the fine particles at the analysis surface was detected and the element concentration (concentration A) was measured. The concentration of the fine particles in a total amount of the alumina particles and the fine particles dispersed in the dispersion medium was converted into the concentration of the element constituting the fine particles, and was used as the concentration B, and the concentration difference (concentration A−concentration B) of each sample was calculated.

As a result, the same results (see Tables 4 to 6) as those obtained by the above-described energy dispersion X-ray spectroscopy (EDS) using a field effect-scanning transmission electron microscope (FE-STEM) were obtained.

TABLE 4

| | | Concentration | |
|---|---|---|---|
| Sample | Composition of | Difference of Fine | Withstand |
| No. | Fine Particle | Particles (%) | Voltage (kV) |
| X1 | — | — | 29 |
| X92 | Y₂O₃ | −50 | 20 |
| X93 | Y₂O₃ | −40 | 21 |
| X94 | Y₂O₃ | −30 | 22 |
| X95 | Y₂O₃ | −20 | 36 |
| X96 | Y₂O₃ | −10 | 41 |
| X97 | Y₂O₃ | 0 | 42 |
| X98 | Y₂O₃ | 10 | 41 |
| X99 | Y₂O₃ | 20 | 35 |
| X100 | Y₂O₃ | 30 | 22 |
| X101 | Y₂O₃ | 40 | 21 |
| X102 | Y₂O₃ | 50 | 21 |
| X103 | MgO | −50 | 20 |
| X104 | MgO | −40 | 21 |
| X105 | MgO | −30 | 23 |
| X106 | MgO | −20 | 37 |
| X107 | MgO | −10 | 41 |
| X108 | MgO | 0 | 42 |
| X109 | MgO | 10 | 41 |
| X110 | MgO | 20 | 36 |
| X111 | MgO | 30 | 23 |
| X112 | MgO | 40 | 21 |
| X113 | MgO | 50 | 21 |
| X114 | SiO₂ | −50 | 19 |
| X115 | SiO₂ | −40 | 19 |
| X116 | SiO₂ | −30 | 21 |
| X117 | SiO₂ | −20 | 35 |
| X118 | SiO₂ | −10 | 40 |
| X119 | SiO₂ | 0 | 41 |
| X120 | SiO₂ | 10 | 40 |
| X121 | SiO₂ | 20 | 34 |
| X122 | SiO₂ | 30 | 21 |
| X123 | SiO₂ | 40 | 21 |
| X124 | SiO₂ | 50 | 21 |

TABLE 5

| | | Concentration | |
|---|---|---|---|
| Sample | Composition of | Difference of Fine | Withstand |
| No. | Fine Particle | Particles (%) | Voltage (kV) |
| X125 | ZrO₂ | −50 | 20 |
| X126 | ZrO₂ | −40 | 21 |
| X127 | ZrO₂ | −30 | 22 |
| X128 | ZrO₂ | −20 | 36 |
| X129 | ZrO₂ | −10 | 41 |
| X130 | ZrO₂ | 0 | 42 |
| X131 | ZrO₂ | 10 | 41 |
| X132 | ZrO₂ | 20 | 36 |
| X133 | ZrO₂ | 30 | 22 |
| X134 | ZrO₂ | 40 | 21 |
| X135 | ZrO₂ | 50 | 21 |
| X136 | Lu₂O₃ | −50 | 20 |
| X137 | Lu₂O₃ | −40 | 21 |
| X138 | Lu₂O₃ | −30 | 22 |
| X139 | Lu₂O₃ | −20 | 36 |
| X140 | Lu₂O₃ | −10 | 41 |
| X141 | Lu₂O₃ | 0 | 42 |
| X142 | Lu₂O₃ | 10 | 41 |
| X143 | Lu₂O₃ | 20 | 36 |
| X144 | Lu₂O₃ | 30 | 22 |
| X145 | Lu₂O₃ | 40 | 21 |
| X146 | Lu₂O₃ | 50 | 21 |
| X147 | NdAlO₃ | −50 | 20 |
| X148 | NdAlO₃ | −40 | 21 |
| X149 | NdAlO₃ | −30 | 22 |
| X150 | NdAlO₃ | −20 | 34 |
| X151 | NdAlO₃ | −10 | 41 |
| X152 | NdAlO₃ | 0 | 42 |
| X153 | NdAlO₃ | 10 | 41 |
| X154 | NdAlO₃ | 20 | 34 |
| X155 | NdAlO₃ | 30 | 22 |
| X156 | NdAlO₃ | 40 | 21 |
| X157 | NdAlO₃ | 50 | 21 |

TABLE 6

| | | Concentration | |
|---|---|---|---|
| Sample | Composition of | Difference of Fine | Withstand |
| No. | Fine Particle | Particles (%) | Voltage (kV) |
| X158 | ZrSiO₄ | −50 | 20 |
| X159 | ZrSiO₄ | −40 | 21 |
| X160 | ZrSiO₄ | −30 | 22 |
| X161 | ZrSiO₄ | −20 | 37 |
| X162 | ZrSiO₄ | −10 | 42 |
| X163 | ZrSiO₄ | 0 | 43 |
| X164 | ZrSiO₄ | 10 | 42 |
| X165 | ZrSiO₄ | 20 | 37 |
| X166 | ZrSiO₄ | 30 | 23 |
| X167 | ZrSiO₄ | 40 | 21 |
| X168 | ZrSiO₄ | 50 | 21 |
| X169 | Nb₂O₅ | −50 | 20 |
| X170 | Nb₂O₅ | −40 | 21 |
| X171 | Nb₂O₅ | −30 | 22 |
| X172 | Nb₂O₅ | −20 | 36 |
| X173 | Nb₂O₅ | −10 | 41 |
| X174 | Nb₂O₅ | 0 | 42 |
| X175 | Nb₂O₅ | 10 | 41 |
| X176 | Nb₂O₅ | 20 | 36 |
| X177 | Nb₂O₅ | 30 | 22 |
| X178 | Nb₂O₅ | 40 | 21 |
| X179 | Nb₂O₅ | 50 | 21 |
| X180 | Nd₂O₃ | −50 | 20 |
| X181 | Nd₂O₃ | −40 | 21 |
| X182 | Nd₂O₃ | −30 | 22 |
| X183 | Nd₂O₃ | −20 | 36 |
| X184 | Nd₂O₃ | −10 | 41 |
| X185 | Nd₂O₃ | 0 | 42 |
| X186 | Nd₂O₃ | 10 | 41 |
| X187 | Nd₂O₃ | 20 | 34 |
| X188 | Nd₂O₃ | 30 | 22 |
| X189 | Nd₂O₃ | 40 | 21 |
| X190 | Nd₂O₃ | 50 | 21 |

As can be seen from Tables 4 to 6, each of the samples (Samples X95 to X99, Samples X106 to X110, Samples X117 to X121, Samples X128 to X132, Samples X150 to X154, Samples X161 to X165, Samples X172 to X176, and Samples X183 to X187), in which the concentration difference of the fine particles is within ±20 wt %, exhibited a high withstand voltage of 34 kV or more. The concentration difference of the fine particles is more preferably within ±10 wt %, and in this case, a withstand voltage as high as 40 kV or more can be exhibited. The alumina composite sintered body exhibiting such a high withstand voltage is suitable for an insulating material of a spark plug and enables downsizing of the spark plug.

### Example 3

In this Example, a plurality of alumina composite sintered bodies are produced, in which when arbitrary regions with the area of 100 μm×100 μm in the cross-section of the alumina composite sintered body is taken as analysis surfaces at least at 20 portions adjacent to each other, the cross-sectional area of each fine particle contained in each analysis surface is measured, and the cross-sectional area is converted into a circle having the same area, the diameter of the circle (the equivalent-circle diameter of the fine particle) is different.

In this Example, first, 13 kinds of alumina composite sintered bodies (Samples X191 to X203) containing the fine particles comprising Y₂O₃ and differing in the equivalent-circle diameter of the fine particle are produced.

More specifically, similarly to Example 1, an alumina particle powder having an average particle diameter of 0.4 to 1.0 μm and comprising alumina having a purity of 99.9% or more was prepared. In addition, a sintering assistant comprising SiO₂ (silicon oxide) was prepared. Furthermore, fine particles having an average particle diameter of 100 nm and comprising Y₂O₃ were prepared. The average particle diameter of the fine particles is an arithmetic average particle diameter of 100 particles observed by a transmission electron microscope (TEM). The maximum diameter of these fine particles was less than 1 μm.

Subsequently, 100 parts by weight of the alumina particle powder, 2 parts by weight of the sintering assistant and 0.2 parts by weight of the fine particles were dispersed in water to produce the raw material mixture slurry. The production of this raw material mixture slurry was performed by the same method as in Example 1.

The raw material mixture slurry obtained above was dried by spray drying and granulating to obtain a granulated powder. The granulated powder was formed into an insulator shape to obtain a powder compact, and the compact then fired to obtain an alumina composite sintered body having an insulator shape. In this Example, 13 kinds of alumina composite sintered bodies were prepared by changing the firing temperature and firing time, and were designated as Samples X191 to X203. The firing temperature was changed in the range from 1,300° C. to 1,600° C., and the firing time was changed in the range from 1 hour to 3 hours.

In addition, in this Example, 104 kinds of alumina composite sintered bodies (Samples X204 to X307) were prepared using the fine particles each having a composition different from those of Samples X191 to X203.

In other words, Samples X204 to X216 were prepared according to the same production method as Samples X191 to X203, except for using the fine particles comprising MgO. In addition, Samples X204 to X216 were prepared by changing the firing conditions (temperature and time). The firing temperature was changed in the range from 1,300° C. to 1,600° C., and the firing time was changed in the range from 1 hour to 3 hours.

Samples X217 to X229 were prepared according to the same production method as Samples X191 to X203, except for using the fine particles comprising SiO₂. In addition, Samples X217 to X229 were prepared by changing the firing conditions (temperature and time). The firing temperature was changed in the range from 1,300° C. to 1,600° C., and the firing time was changed in the range from 1 hour to 3 hours.

Samples X230 to X242 were prepared according to the same production method as Samples X191 to X203, except for using the fine particles comprising ZrO₂. In addition, Samples X230 to X242 were prepared by changing the firing conditions (temperature and time). The firing temperature was changed in the range from 1,300° C. to 1,600° C., and the firing time was changed in the range from 1 hour to 3 hours.

Samples X243 to X255 were prepared according to the same production method as Samples X191 to X203, except for using the fine particles comprising Lu₂O₃. In addition, Samples X243 to X255 were prepared by changing the firing conditions (temperature and time). The firing temperature was changed in the range from 1,300° C. to 1,600° C., and the firing time was changed in the range from 1 hour to 3 hours.

Samples X256 to X268 were prepared according to the same production method as Samples X191 to X203, except for using the fine particles comprising NdAlO₃. In addition, Samples X256 to X268 were prepared by changing the firing conditions (temperature and time). The firing temperature was changed in the range from 1,300° C. to 1,600° C., and the firing time was changed in the range from 1 hour to 3 hours.

Samples X269 to X281 were prepared according to the same production method as Samples X191 to X203, except for using the fine particles comprising ZrSiO₄. In addition, Samples X269 to X281 were prepared by changing the firing conditions (temperature and time). The firing temperature was changed in the range from 1,300° C. to 1,600° C., and the firing time was changed in the range from 1 hour to 3 hours.

Samples X282 to X294 were prepared according to the same production method as Samples X191 to X203, except for using the fine particles comprising Nb₂O₅. In addition, Samples X282 to X294 were prepared by changing the firing conditions (temperature and time). The firing temperature was changed in the range from 1,300° C. to 1,600° C., and the firing time was changed in the range from 1 hour to 3 hours.

Samples X295 to X307 were prepared according to the same production method as Samples X191 to X203, except for using the fine particles comprising Nd₂O₃. In addition, Samples X295 to X307 were prepared by changing the firing conditions (temperature and time). The firing temperature was changed in the range from 1,300° C. to 1,600° C., and the firing time was changed in the range from 1 hour to 3 hours.

The withstand voltage of each of Samples X191 to X307 produced in this Example was measured in the same manner as in Example 1. The results are shown in Tables 7 to 11. In Table 7, the result of withstand voltage of Sample X1 not containing the fine particle (see Example 1) is shown together for comparison.

Using each sample (Samples X191 to X307), the equivalent-circle diameter of the fine particle was measured. In other words, arbitrary regions with the area of 100 μm×100 μm in the cross-section of each sample were taken as analysis surfaces at least at 20 portions adjacent to each other, and the cross-sectional area of each fine particle contained in each analysis surface was measured in the same manner as in Example 1 by performing mapping analysis according to the energy dispersion X-ray spectroscopy (EDS) using a field effect-scanning transmission electron microscope (FE-STEM). By this analysis, the cross-sectional area of the fine particle was detected as a mapping dot image (color dot image) and a single particle (a primary particle) or aggregated particles (a secondary particle) of the fine particles in each analysis surface at 20 portions was observed as a mapping dot image (color dot image). The single particle or the aggregated particles of the fine particles in the mapping dot image is discriminated as a polygon, and the area thereof was determined. The area can be measured using a software effecting all of image processing, image measurement and data processing (for example, “WinROOF” (produced by Mitani Corp.). The obtained area was converted into a circle having the same area, and the diameter of the circle was determined. An average of the diameters obtained above was used as the equivalent-circle diameter of the fine particle. The results are shown in Tables 7 to 11.

The equivalent-circle diameter of the fine particle of each of Samples X191 to X307 was measured also by the electron energy loss spectroscopy (EELS) using an energy filter transmission electron microscope (EFTEM) in the same manner as in Example 1.

As a result, the same results as those obtained by the above-described energy dispersion X-ray spectroscopy (EDS) using a field effect-scanning transmission electron microscope (FE-STEM) (see Tables 7 to 11) were obtained.

The equivalent-circle diameter of the fine particle of each of Samples X191 to X307 was measured also by the high-angle annular dark-field method (HAADF) using a field effect-scanning transmission electron microscope (FE-STEM) in the same manner as in Example 1.

As a result, the same results as those obtained by the above-described energy dispersion X-ray spectroscopy (EDS) using a field effect-scanning transmission electron microscope (FE-STEM) (see Tables 7 to 11) were obtained.

TABLE 7

| | | Equivalent-Circle | |
|---|---|---|---|
| Sample | Composition of | Diameter of Fine | Withstand |
| No. | Fine Particle | Particle (μm) | Voltage (kV) |
| X1 | — | | 29 |
| X191 | Y₂O₃ | 0.1 | 35 |
| X192 | Y₂O₃ | 0.2 | 38 |
| X193 | Y₂O₃ | 0.5 | 42 |
| X194 | Y₂O₃ | 1 | 42 |
| X195 | Y₂O₃ | 2 | 41 |
| X196 | Y₂O₃ | 3 | 39 |
| X197 | Y₂O₃ | 4 | 35 |
| X198 | Y₂O₃ | 5 | 28 |
| X199 | Y₂O₃ | 6 | 20 |
| X200 | Y₂O₃ | 7 | 17 |
| X201 | Y₂O₃ | 8 | 16 |
| X202 | Y₂O₃ | 9 | 15 |
| X203 | Y₂O₃ | 10 | 15 |
| X204 | MgO | 0.1 | 35 |
| X205 | MgO | 0.2 | 38 |
| X206 | MgO | 0.5 | 41 |
| X207 | MgO | 1 | 42 |
| X208 | MgO | 2 | 42 |
| X209 | MgO | 3 | 40 |
| X210 | MgO | 4 | 37 |
| X211 | MgO | 5 | 29 |
| X212 | MgO | 6 | 20 |
| X213 | MgO | 7 | 17 |
| X214 | MgO | 8 | 16 |
| X215 | MgO | 9 | 15 |
| X216 | MgO | 10 | 15 |

TABLE 8

| | | Equivalent-Circle | |
|---|---|---|---|
| Sample | Composition of | Diameter of Fine | Withstand |
| No. | Fine Particle | Particle (μm) | Voltage (kV) |
| X217 | SiO₂ | 0.1 | 33 |
| X218 | SiO₂ | 0.2 | 37 |
| X219 | SiO₂ | 0.5 | 40 |
| X220 | SiO₂ | 1 | 41 |
| X221 | SiO₂ | 2 | 41 |
| X222 | SiO₂ | 3 | 39 |
| X223 | SiO₂ | 4 | 36 |
| X224 | SiO₂ | 5 | 29 |
| X225 | SiO₂ | 6 | 20 |
| X226 | SiO₂ | 7 | 17 |
| X227 | SiO₂ | 8 | 16 |
| X228 | SiO₂ | 9 | 15 |
| X229 | SiO₂ | 10 | 15 |
| X230 | ZrO₂ | 0.1 | 35 |
| X231 | ZrO₂ | 0.2 | 38 |
| X232 | ZrO₂ | 0.5 | 42 |
| X233 | ZrO₂ | 1 | 42 |
| X234 | ZrO₂ | 2 | 41 |
| X235 | ZrO₂ | 3 | 39 |
| X236 | ZrO₂ | 4 | 35 |
| X237 | ZrO₂ | 5 | 28 |
| X238 | ZrO₂ | 6 | 20 |
| X239 | ZrO₂ | 7 | 17 |
| X240 | ZrO₂ | 8 | 16 |
| X241 | ZrO₂ | 9 | 15 |
| X242 | ZrO₂ | 10 | 15 |

TABLE 9

| | | Equivalent-Circle | |
|---|---|---|---|
| Sample | Composition of | Diameter of Fine | Withstand |
| No. | Fine Particle | Particle (μm) | Voltage (kV) |
| X243 | Lu₂O₃ | 0.1 | 35 |
| X244 | Lu₂O₃ | 0.2 | 38 |
| X245 | Lu₂O₃ | 0.5 | 42 |
| X246 | Lu₂O₃ | 1 | 42 |
| X247 | Lu₂O₃ | 2 | 42 |
| X248 | Lu₂O₃ | 3 | 39 |
| X249 | Lu₂O₃ | 4 | 35 |
| X250 | Lu₂O₃ | 5 | 28 |
| X251 | Lu₂O₃ | 6 | 20 |
| X252 | Lu₂O₃ | 7 | 17 |
| X253 | Lu₂O₃ | 8 | 16 |
| X254 | Lu₂O₃ | 9 | 15 |
| X255 | Lu₂O₃ | 10 | 15 |
| X256 | NdAlO₃ | 0.1 | 36 |
| X257 | NdAlO₃ | 0.2 | 41 |
| X258 | NdAlO₃ | 0.5 | 42 |
| X259 | NdAlO₃ | 1 | 42 |
| X260 | NdAlO₃ | 2 | 42 |
| X261 | NdAlO₃ | 3 | 38 |
| X262 | NdAlO₃ | 4 | 32 |
| X263 | NdAlO₃ | 5 | 26 |
| X264 | NdAlO₃ | 6 | 20 |
| X265 | NdAlO₃ | 7 | 17 |
| X266 | NdAlO₃ | 8 | 16 |
| X267 | NdAlO₃ | 9 | 15 |
| X268 | NdAlO₃ | 10 | 15 |

TABLE 10

| | | Equivalent-Circle | |
|---|---|---|---|
| Sample | Composition of | Diameter of Fine | Withstand |
| No. | Fine Particle | Particle (μm) | Voltage (kV) |
| X269 | ZrSiO₄ | 0.1 | 35 |
| X270 | ZrSiO₄ | 0.2 | 38 |
| X271 | ZrSiO₄ | 0.5 | 42 |
| X272 | ZrSiO₄ | 1 | 42 |
| X273 | ZrSiO₄ | 2 | 42 |
| X274 | ZrSiO₄ | 3 | 39 |
| X275 | ZrSiO₄ | 4 | 34 |
| X276 | ZrSiO₄ | 5 | 26 |
| X277 | ZrSiO₄ | 6 | 20 |
| X278 | ZrSiO₄ | 7 | 17 |
| X279 | ZrSiO₄ | 8 | 16 |
| X280 | ZrSiO₄ | 9 | 15 |
| X281 | ZrSiO₄ | 10 | 15 |
| X282 | Nb₂O₅ | 0.1 | 35 |
| X283 | Nb₂O₅ | 0.2 | 38 |
| X284 | Nb₂O₅ | 0.5 | 42 |
| X285 | Nb₂O₅ | 1 | 42 |
| X286 | Nb₂O₅ | 2 | 41 |
| X287 | Nb₂O₅ | 3 | 39 |
| X288 | Nb₂O₅ | 4 | 35 |
| X289 | Nb₂O₅ | 5 | 28 |
| X290 | Nb₂O₅ | 6 | 19 |
| X291 | Nb₂O₅ | 7 | 17 |
| X292 | Nb₂O₅ | 8 | 16 |
| X293 | Nb₂O₅ | 9 | 15 |
| X294 | Nb₂O₅ | 10 | 15 |

TABLE 11

| | | Equivalent-Circle | |
|---|---|---|---|
| Sample | Composition of | Diameter of Fine | Withstand |
| No. | Fine Particle | Particle (μm) | Voltage (kV) |
| X295 | Nd₂O₃ | 0.1 | 35 |
| X296 | Nd₂O₃ | 0.2 | 38 |
| X297 | Nd₂O₃ | 0.5 | 42 |
| X298 | Nd₂O₃ | 1 | 42 |
| X299 | Nd₂O₃ | 2 | 41 |
| X300 | Nd₂O₃ | 3 | 39 |
| X301 | Nd₂O₃ | 4 | 35 |
| X302 | Nd₂O₃ | 5 | 27 |
| X303 | Nd₂O₃ | 6 | 20 |
| X304 | Nd₂O₃ | 7 | 17 |
| X305 | Nd₂O₃ | 8 | 16 |
| X306 | Nd₂O₃ | 9 | 15 |
| X307 | Nd₂O₃ | 10 | 15 |

As can be seen from Tables 7 to 11, samples (Samples X191 to X197, Samples X204 to X210, Samples X217 to X223, Samples X230 to X236, Samples X243 to X249, Samples X256 to X262, Samples X269 to X275, Samples X282 to X288 and Samples X295 to X301), where the equivalent-circle diameter of the fine particle is from 0.1 to 4 μm, exhibited a high withstand voltage of 33 kV or more. The equivalent-circle diameter of the fine particle is more preferably from 0.2 μm to 3 μm, and in this case, a withstand voltage as high as 37 kV or more can be exhibited. The alumina composite sintered body exhibiting such a high withstand voltage is suitable for an insulating material of a spark plug and enables downsizing of the spark plug.

### Example 4

In this Example, alumina composite sintered bodies, where fine particles are dispersed in the crystal grains and/or at the crystal grain boundaries of an alumina sintered body obtained by sintering alumina crystal grains, are produced using various fine particles differing in the composition.

In this Example, as shown in Tables 12 and 13 later, 61 kinds of alumina composite sintered bodies (Samples X308 to X368) were prepared using the fine particles comprising various compounds according to the same production method as in Example 1 (see Tables 12 and 13).

Samples (Samples X308 to X368) each is an alumina composite sintered body produced by having been fired at a firing temperature of 1,500° C. for a firing time of 1 hour, and other conditions which are the same as in Example 1. In addition, the area ratio of the fine particles in each sample (Samples X308 to X368) of this Example was measured in the same manner as in Example 1, and was found to be about 5% in all samples.

The withstand voltage of each sample produced in this Example was measured in the same manner as in Example 1. The results are shown in Tables 12 and 13.

TABLE 12

| | Composition of Fine | Withstand Voltage |
|---|---|---|
| Sample No. | Particle | (kV/mm) |
| X308 | Al₂O₃ | 42 |
| X309 | SiO₂ | 41 |
| X310 | MgO | 42 |
| X311 | Y₂O₃ | 42 |
| X312 | ZrO₂ | 41 |
| X313 | Sc₂O₃ | 41 |
| X314 | TiO₂ | 41 |
| X315 | Cr₂O₃ | 40 |
| X316 | Mn₂O₃ | 39 |
| X317 | MnO | 39 |
| X318 | Fe₂O₃ | 39 |
| X319 | NiO | 39 |
| X320 | CuO | 39 |
| X321 | ZnO | 39 |
| X322 | Ga₂O₃ | 39 |
| X323 | Nb₂O₅ | 39 |
| X324 | La₂O₃ | 41 |
| X325 | CeO₂ | 41 |
| X326 | Pr₂O₃ | 41 |
| X327 | Pr₆O₁₁ | 41 |
| X328 | Nd₂O₃ | 41 |
| X329 | Pm₂O₃ | 41 |
| X330 | Sm₂O₃ | 41 |
| X331 | Eu₂O₃ | 41 |
| X332 | Gd₂O₃ | 41 |
| X333 | Tb₂O₃ | 41 |
| X334 | Dy₂O₃ | 41 |
| X335 | Ho₂O₃ | 41 |
| X336 | Er₂O₃ | 41 |
| X337 | Tm₂O₃ | 41 |
| X338 | Yb₂O₃ | 41 |
| X339 | Lu₂O₃ | 41 |

TABLE 13

| | Composition of Fine | Withstand Voltage |
|---|---|---|
| Sample No. | Particle | (kV/mm) |
| X340 | HfO₂ | 40 |
| X341 | Ta₂O₅ | 40 |
| X342 | WO₃ | 39 |
| X343 | MgAl₂O₄ | 39 |
| X344 | Al₂SiO₅ | 41 |
| X345 | 3Al₂O₃•2SiO₂ | 40 |
| X346 | YAlO₃ | 41 |
| X347 | Y₃Al₅O₁₁ | 41 |
| X348 | LaAlO₃ | 40 |
| X349 | CeAlO₃ | 40 |
| X350 | NdAlO₃ | 40 |
| X351 | PrAlO₃ | 40 |
| X352 | SmAlO₃ | 40 |
| X353 | EuAlO₃ | 40 |
| X354 | GdAlO₃ | 40 |
| X355 | TbAlO₃ | 40 |
| X356 | DyAlO₃ | 40 |
| X357 | HoAlO₃ | 40 |
| X358 | YbAlO₃ | 40 |
| X359 | LuAlO₃ | 40 |
| X360 | YSiO₄ | 42 |
| X361 | ZrSiO₄ | 41 |
| X362 | CaSiO₃ | 40 |
| X363 | 2MgO•SiO₂ | 40 |
| X364 | MgO•Al₂O₃ | 40 |
| X365 | MgSiO₃ | 40 |
| X366 | MgO•SiO₂ | 40 |
| X367 | MgCrO₃ | 40 |
| X368 | MgSiO₃ | 40 |

As can be seen from Tables 12 and 13, the alumina composite sintered body of Samples X308 to X368, where the area ratio is about 5% despite of using various fine particles differing in the composition, exhibited a high withstand voltage of 39 kV or more.

### Example 5

In this Example, alumina composite sintered bodies containing fine particles differing in the composition at a different blending ratio are produced and their withstand voltage is evaluated.

More specifically, first, the same alumina particle powder, fine particles comprising Y₂O₃, and sintering assistant as in Example 1 were prepared.

Subsequently, 89 wt % of the alumina particle powder, 10 wt % of the fine particles and 1 wt % of the sintering assistant were dispersed in water to produce the raw material mixture slurry. The production of the raw material mixture slurry was performed by the same dispersion method as in Example 1. Then, in the same manner as in Example 1, the raw material mixture slurry was dried to produce a granulated powder, and the granulated powder was formed to obtain a shaped article. The shaped article was fired at a firing temperature of 1,500° C. for 1 hour to obtain an alumina composite sintered body (Sample X369).

In addition, in this Example, 89 kinds of alumina composite sintered bodies (Samples X370 to X458) were further produced in the same manner as Sample X369, except that as shown in Tables 14 to 16 below, the composition and blending ratio of the fine particles were changed from Sample X369 (see Tables 14 to 16). The withstand voltage of each sample (Samples X369 to X458) was measured in the same manner as in Example 1. The results are shown in Tables 14 to 16.

TABLE 14

| | | Compositional Ratio (wt %) | | | |
|---|---|---|---|---|---|
| | Composition | Main | | | Withstand |
| Sample | of Fine | Component | Fine | Sintering | Voltage |
| No. | Particle | (alumina) | Particles | assistant | (kV/mm) |
| X369 | Y₂O₃ | 89 | 10 | 1 | 32 |
| X370 | Y₂O₃ | 94 | 5 | 1 | 36 |
| X371 | Y₂O₃ | 97 | 2 | 1 | 42 |
| X372 | Y₂O₃ | 98 | 1 | 1 | 42 |
| X373 | Y₂O₃ | 98.5 | 0.5 | 1 | 39 |
| X374 | Y₂O₃ | 98.8 | 0.2 | 1 | 39 |
| X375 | Y₂O₃ | 98.9 | 0.1 | 1 | 37 |
| X376 | Y₂O₃ | 98.95 | 0.05 | 1 | 36 |
| X377 | Y₂O₃ | 98.98 | 0.02 | 1 | 34 |
| X378 | Y₂O₃ | 98.99 | 0.01 | 1 | 31 |
| X379 | MgO | 89 | 10 | 1 | 31 |
| X380 | MgO | 94 | 5 | 1 | 35 |
| X381 | MgO | 97 | 2 | 1 | 41 |
| X382 | MgO | 98 | 1 | 1 | 42 |
| X383 | MgO | 98.5 | 0.5 | 1 | 39 |
| X384 | MgO | 98.8 | 0.2 | 1 | 38 |
| X385 | MgO | 98.9 | 0.1 | 1 | 36 |
| X386 | MgO | 98.95 | 0.05 | 1 | 35 |
| X387 | MgO | 98.98 | 0.02 | 1 | 33 |
| X388 | MgO | 98.99 | 0.01 | 1 | 31 |
| X389 | SiO₂ | 89 | 10 | 1 | 32 |
| X390 | SiO₂ | 94 | 5 | 1 | 35 |
| X391 | SiO₂ | 97 | 2 | 1 | 42 |
| X392 | SiO₂ | 98 | 1 | 1 | 41 |
| X393 | SiO₂ | 98.5 | 0.5 | 1 | 40 |
| X394 | SiO₂ | 98.8 | 0.2 | 1 | 39 |
| X395 | SiO₂ | 98.9 | 0.1 | 1 | 37 |
| X396 | SiO₂ | 98.95 | 0.05 | 1 | 35 |
| X397 | SiO₂ | 98.98 | 0.02 | 1 | 33 |
| X398 | SiO₂ | 98.99 | 0.01 | 1 | 30 |

TABLE 15

| | | Compositional Ratio (wt %) | | | |
|---|---|---|---|---|---|
| | Composition | Main | | | Withstand |
| Sample | of Fine | Component | Fine | Sintering | Voltage |
| No. | Particle | (alumina) | Particles | assistant | (kV/mm) |
| X399 | ZrO₂ | 89 | 10 | 1 | 32 |
| X400 | ZrO₂ | 94 | 5 | 1 | 36 |
| X401 | ZrO₂ | 97 | 2 | 1 | 41 |
| X402 | ZrO₂ | 98 | 1 | 1 | 42 |
| X403 | ZrO₂ | 98.5 | 0.5 | 1 | 40 |
| X404 | ZrO₂ | 98.8 | 0.2 | 1 | 39 |
| X405 | ZrO₂ | 98.9 | 0.1 | 1 | 37 |
| X406 | ZrO₂ | 98.95 | 0.05 | 1 | 36 |
| X407 | ZrO₂ | 98.98 | 0.02 | 1 | 34 |
| X408 | ZrO₂ | 98.99 | 0.01 | 1 | 31 |
| X409 | Lu₂O₃ | 89 | 10 | 1 | 32 |
| X410 | Lu₂O₃ | 94 | 5 | 1 | 36 |
| X411 | Lu₂O₃ | 97 | 2 | 1 | 41 |
| X412 | Lu₂O₃ | 98 | 1 | 1 | 41 |
| X413 | Lu₂O₃ | 98.5 | 0.5 | 1 | 41 |
| X414 | Lu₂O₃ | 98.8 | 0.2 | 1 | 39 |
| X415 | Lu₂O₃ | 98.9 | 0.1 | 1 | 37 |
| X416 | Lu₂O₃ | 98.95 | 0.05 | 1 | 36 |
| X417 | Lu₂O₃ | 98.98 | 0.02 | 1 | 34 |
| X418 | Lu₂O₃ | 98.99 | 0.01 | 1 | 31 |
| X419 | NdAlO₃ | 89 | 10 | 1 | 31 |
| X420 | NdAlO₃ | 94 | 5 | 1 | 36 |
| X421 | NdAlO₃ | 97 | 2 | 1 | 41 |
| X422 | NdAlO₃ | 98 | 1 | 1 | 42 |
| X423 | NdAlO₃ | 98.5 | 0.5 | 1 | 40 |
| X424 | NdAlO₃ | 98.8 | 0.2 | 1 | 39 |
| X425 | NdAlO₃ | 98.9 | 0.1 | 1 | 37 |
| X426 | NdAlO₃ | 98.95 | 0.05 | 1 | 36 |
| X427 | NdAlO₃ | 98.98 | 0.02 | 1 | 34 |
| X428 | NdAlO₃ | 98.99 | 0.01 | 1 | 31 |

TABLE 16

| | | Compositional Ratio (wt %) | | | |
|---|---|---|---|---|---|
| | Composition | Main | | | Withstand |
| Sample | of Fine | Component | Fine | Sintering | Voltage |
| No. | Particle | (alumina) | Particles | assistant | (kV/mm) |
| X429 | ZrSiO₄ | 89 | 10 | 1 | 31 |
| X430 | ZrSiO₄ | 94 | 5 | 1 | 36 |
| X431 | ZrSiO₄ | 97 | 2 | 1 | 41 |
| X432 | ZrSiO₄ | 98 | 1 | 1 | 42 |
| X433 | ZrSiO₄ | 98.5 | 0.5 | 1 | 40 |
| X434 | ZrSiO₄ | 98.8 | 0.2 | 1 | 39 |
| X435 | ZrSiO₄ | 98.9 | 0.1 | 1 | 37 |
| X436 | ZrSiO₄ | 98.95 | 0.05 | 1 | 36 |
| X437 | ZrSiO₄ | 98.98 | 0.02 | 1 | 34 |
| X438 | ZrSiO₄ | 98.99 | 0.01 | 1 | 31 |
| X439 | Nb₂O₅ | 89 | 10 | 1 | 32 |
| X440 | Nb₂O₅ | 94 | 5 | 1 | 36 |
| X441 | Nb₂O₅ | 97 | 2 | 1 | 40 |
| X442 | Nb₂O₅ | 98 | 1 | 1 | 41 |
| X443 | Nb₂O₅ | 98.5 | 0.5 | 1 | 41 |
| X444 | Nb₂O₅ | 98.8 | 0.2 | 1 | 39 |
| X445 | Nb₂O₅ | 98.9 | 0.1 | 1 | 37 |
| X446 | Nb₂O₅ | 98.95 | 0.05 | 1 | 36 |
| X447 | Nb₂O₅ | 98.98 | 0.02 | 1 | 34 |
| X448 | Nb₂O₅ | 98.99 | 0.01 | 1 | 30 |
| X449 | Nd₂O₃ | 89 | 10 | 1 | 32 |
| X450 | Nd₂O₃ | 94 | 5 | 1 | 36 |
| X451 | Nd₂O₃ | 97 | 2 | 1 | 41 |
| X452 | Nd₂O₃ | 98 | 1 | 1 | 41 |
| X453 | Nd₂O₃ | 98.5 | 0.5 | 1 | 40 |
| X454 | Nd₂O₃ | 98.8 | 0.2 | 1 | 39 |
| X455 | Nd₂O₃ | 98.9 | 0.1 | 1 | 37 |
| X456 | Nd₂O₃ | 98.95 | 0.05 | 1 | 36 |
| X457 | Nd₂O₃ | 98.98 | 0.02 | 1 | 34 |
| X458 | Nd₂O₃ | 98.99 | 0.01 | 1 | 30 |

As can be seen from Tables 14 to 16, the alumina composite sintered bodies containing the fine particles in an amount of 0.0 wt % 5 to 5 wt % (Samples X370 to X376, Samples X380 to X386, Samples X390 to X396, Samples X400 to X406, Samples X410 to X416, Samples X420 to X426, Samples X430 to X436, Samples X440 to X446 and Samples X450 to X456) can exhibit a high withstand voltage of 35 kV or more.

In addition, the area ratio of the fine particles in each of these samples (Samples X370 to X376, Samples X380 to X386, Samples X390 to X396, Samples X400 to X406, Samples X410 to X416, Samples X420 to X426, Samples X430 to X436, Samples X440 to X446 and Samples X450 to X456) was measured in the same manner as in Example 1, and as a result, the area ratio was from 1 to 20% in all samples.

1. An alumina composite sintered body comprising alumina as a main component,
wherein fine particles having a melting point of 1,300° C. or more, and comprising primary particles having an average particle diameter of 200 nm or less and a maximum particle diameter of 1 μm or less, and/or secondary particles resulting from aggregation of the primary particles are dispersed in crystal grains and/or at crystal grain boundaries of an alumina sintered body obtained by sintering alumina crystal grains comprising alumina, and
wherein, when an arbitrary region of 10 μm×10 μm in the cross-section of the alumina composite sintered body is taken as an analysis surface, and the cross-sectional areas of the fine particles contained in each of the analysis surfaces at least at 20 portions are measured, the ratio of the cross-sectional areas of the fine particles occupying in the area of the analysis surface is from 1% to 20%.

2. An alumina composite sintered body comprising alumina as a main component,
wherein fine particles having a melting point of 1,300° C. or more, and comprising primary particles having an average particle diameter of 200 nm or less and a maximum particle diameter of 1 μm or less, and/or secondary particles resulting from aggregation of the primary particles are dispersed in crystal grains and/or at crystal grain boundaries of an alumina sintered body obtained by sintering alumina crystal grains comprising alumina, and
wherein, when an arbitrary region of 100 μm×100 μm in the cross-section of the alumina composite sintered body is taken as an analysis surface, the cross-sectional areas of the fine particles contained in each of the analysis surfaces at least at 20 portions adjacent to each other are measured, and each of the cross-sectional areas is converted into a circle having the same area, the diameter of the circle is from 0.1 μm to 4 μm.

3. The alumina composite sintered body according to claim 1, wherein the cross-sectional areas of said fine particles at said analysis surface are measured by detecting the cross-sectional areas of the fine particles at the analysis surface as a mapping dot image by performing a mapping analysis at the analysis surface via an energy dispersion type X-ray spectroscopy using a field effect-scanning transmission electron microscope to measure the areas of the dots in the mapping dot image.

4. The alumina composite sintered body according to claim 1, wherein the cross-sectional areas of said fine particles at said analysis surface are measured by detecting the cross-sectional areas of the fine particles at the analysis surface as a mapping dot image by performing a mapping analysis at the analysis surface via an electron energy loss spectroscopy using an energy filter transmission electron microscope to measure the areas of the dots in the mapping dot image.

5. The alumina composite sintered body according to claim 1, wherein the cross-sectional areas of said fine particles at said analysis surface are measured by detecting the cross-sectional areas of the fine particles at the analysis surface as a mapping dot image by performing a mapping analysis at the analysis surface via a high-angle annular dark-field method using a field effect-scanning transmission electron microscope to measure the areas of the dots in the mapping dot image.

6. An alumina composite sintered body comprising alumina as a main component,
wherein fine particles having a melting point of 1,300° C. or more, and comprising primary particles having an average particle diameter of 200 nm or less and a maximum particle diameter of 1 μm or less, and/or secondary particles resulting from aggregation of the primary particles are dispersed in crystal grains and/or at crystal grain boundaries of an alumina sintered body obtained by sintering alumina crystal grains comprising alumina,
wherein the alumina composite sintered body has been formed by dispersing a powder of the fine particles and a powder of alumina particles at a predetermined blending ratio in a dispersion medium to prepare raw material mixture slurry, and forming and firing the raw material mixture slurry, and
wherein, when an arbitrary region of 10 m×10 μm in the cross-section of the alumina composite sintered body is taken as an analysis surface, and with respect to the analysis surfaces at least at 10 portions, the concentration A (wt %) of the fine particles contained in each of the analysis surfaces is compared with the concentration B (wt %) of the fine particles in a total amount of the alumina particles and the fine particles dispersed in the dispersion medium, the difference between the concentration A and the concentration B is within ±20 wt %.

7. The alumina composite sintered body according to claim 6, wherein the concentration A of said fine particles contained in said analysis surface is measured by performing a mapping analysis via an energy dispersion X-ray spectroscopy using a field effect-scanning transmission electron microscope with respect to a region after 10,000-fold enlargement of the analysis surface.

8. The alumina composite sintered body according to claim 6, wherein the concentration A of said fine particles contained in said analysis surface is measured by performing a mapping analysis via an electron energy loss spectroscopy using an energy filter transmission electron microscope with respect to a region after 10,000-fold enlargement of the analysis surface.

9. The alumina composite sintered body according to claim 6, wherein the concentration A of said fine particles contained in said analysis surface is measured by performing a mapping analysis via a high-angle annular dark-field method using a field effect-scanning transmission electron microscope with respect to a region after 10,000-fold enlargement of the analysis surface.

10. An alumina composite sintered body according to claim 1, wherein said fine particle comprises one or more species selected from Al₂O₃, SiO₂, MgO, Y₂O₃, ZrO₂, Sc₂O₃, TiO₂, Cr₂O₃, Mn₂O₃, MnO, Fe₂O₃, NiO, CuO, ZnO, Ga₂O₃, Nb₂O₅, La₂O₃, CeO₂, Pr₂O₃, Pr₆O₁₁, Nd₂O₃, Pm₂O₃, Sm₂O₃, Eu₂O₃, Gd₂O₃, Tb₂O₃, Dy₂O₃, Ho₂O₃, Er₂O₃, Tm₂O₃, Yb₂O₃, Lu₂O₃, HfO₂, Ta₂O₅, WO₃, MgAl₂O₄, Al₂SiO₅, 3Al₂O₃.2SiO₂, YAlO₃, Y₃Al₅O₁₂, LaAlO₃, CeAlO₃, NdAlO₃, PrAlO₃, SmAlO₃, EuAlO₃, GdAlO₃, TbAlO₃, DyAlO₃, HoAlO₃, YbAlO₃, LuAlO₃, Y₂SiO₅, ZrSiO₄, CaSiO₃, 2MgO.SiO₂, MgO.SiO₂, MgSiO₃ and MgCr₂O₄.

11. An alumina composite sintered body according to claim 1, wherein said alumina composite sintered body contains said fine particles in an amount of 0.05 wt % to 5 wt %.

12. An alumina composite sintered body according to claim 1, wherein said alumina composite sintered body contains a Si compound containing a Si element as a sintering assistant.

13. A spark plug, wherein said alumina composite sintered body claimed in claim 1 has been used as an insulating material.

14. A spark plug comprising a metal fitting having a fitting screw part provided on an outer circumferential periphery thereof, a insulator fixed inside the metal fitting, a center electrode fixed inside the insulator so as for its distal end to protrude from the insulator, and a ground electrode fixed to the metal fitting to face the distal end of the center electrode through a spark discharge gap,
wherein the nominal diameter of the fitting screw part is M10 or less, and the alumina composite sintered body claimed in claim 1 is used as the insulator.

15. An evaluation method for an alumina composite sintered body to be used as an insulating material of a spark plug, comprising using the alumina composite sintered body as an insulating material of the spark plug,
wherein the alumina composite sintered body comprises alumina as a main component, in which fine particles having a melting point of 1,300° C. or more, and comprising primary particles having an average particle diameter of 200 nm or less and a maximum particle diameter of 1 μm or less, and/or secondary particles resulting from aggregation of the primary particles are dispersed in crystal grains and/or at crystal grain boundaries of an alumina sintered body obtained by sintering alumina crystal grains comprising alumina, and
wherein, when an arbitrary region of 10 μm×10 μm in the cross-section of the alumina composite sintered body is taken as an analysis surface, and the cross-sectional areas of the fine particles contained in each of the analysis surfaces at least at 20 portions are measured, the ratio of the cross-sectional areas of the fine particles occupying in the area of the analysis surface is from 1% to 20%.

16. An evaluation method for an alumina composite sintered body to be used as an insulating material of a spark plug, comprising using the alumina composite sintered body as the insulating material of the spark plug,
wherein the alumina composite sintered body comprises alumina as a main component, in which fine particles having a melting point of 1,300 C or more, and comprising primary particles having an average particle diameter of 200 nm or less and a maximum particle diameter of 1 μm or less, and/or secondary particles resulting from aggregation of the primary particles are dispersed in crystal grains and/or at crystal grain boundaries of an alumina sintered body obtained by sintering alumina crystal grains comprising alumina, and
wherein, when an arbitrary region of 100 μm×100 μm in the cross-section of the alumina composite sintered body is taken as an analysis surface, the cross-sectional areas of the fine particles contained in each of the analysis surfaces at least at 20 portions adjacent to each other are measured, and each of the cross-sectional areas is converted into a circle having the same area, the diameter of the circle is from 0.1 μm to 4 μm.

17. The evaluation method for an alumina composite sintered body according to claim 15, wherein the measurement of the cross-sectional areas of said fine particles at said analysis surface is performed by detecting the cross-sectional areas of the fine particles at the analysis surface as a mapping dot image by performing a mapping analysis at the analysis surface via an energy dispersion type X-ray spectroscopy using a field effect-scanning transmission electron microscope to measure the areas of the dots in the mapping dot image.

18. The evaluation method for an alumina composite sintered body according to claim 15, wherein the measurement of the cross-sectional areas of said fine particles at said analysis surface is performed by detecting the cross-sectional areas of the fine particles at the analysis surface as a mapping dot image by performing a mapping analysis at the analysis surface via an electron energy loss spectroscopy using an energy filter transmission electron microscope to measure the areas of the dots in the mapping dot image.

19. The evaluation method for an alumina composite sintered body according to claim 15, wherein the measurement of the cross-sectional areas of said fine particles at said analysis surface is performed by detecting the cross-sectional areas of the fine particles at the analysis surface as a mapping dot image by performing a mapping analysis at the analysis surface via a high-angle annular dark-field method using a field effect-scanning transmission electron microscope to measure the areas of the dots in the mapping dot image.

20. An evaluation method for an alumina composite sintered body to be used as an insulating material of a spark plug, comprising using the alumina composite sintered body as the insulating material of the spark plug,
wherein the alumina composite sintered body comprises alumina as a main component, in which fine particles having a melting point of 1,300° C. or more, and comprising primary particles having an average particle diameter of 200 nm or less and a maximum particle diameter of 1 μm or less, and/or secondary particles resulting from aggregation of the primary particles are dispersed in crystal grains and/or at crystal grain boundaries of an alumina sintered body obtained by sintering alumina crystal grains comprising alumina,
wherein the alumina composite sintered body is formed by dispersing a powder of the fine particles and a powder of alumina particles at a predetermined blending ratio in a dispersion medium to prepare raw material mixture slurry, and forming and firing the raw material mixture slurry, and
wherein, when an arbitrary region of 10 μm×10 μm in the cross-section of the alumina composite sintered body is taken as an analysis surface, and with respect to the analysis surfaces at least at 10 portions, the concentration A (wt %) of the fine particles contained in each of the analysis surfaces is compared with the concentration B (wt %) of the fine particles in a total amount of the alumina particles and the fine particles dispersed in the dispersion medium, the difference between the concentration A and the concentration B is within ±20 wt %.

21. The evaluation method for an alumina composite sintered body according to claim 20, wherein the concentration A of said fine particles contained in said analysis surface is measured by performing a mapping analysis via an energy dispersion X-ray spectroscopy using a field effect-scanning transmission electron microscope with respect to a region after 10,000-fold enlargement of the analysis surface.

22. The evaluation method for an alumina composite sintered body according to claim 20, wherein the concentration A of said fine particles contained in said analysis surface is measured by performing a mapping analysis via an electron energy loss spectroscopy using an energy filter transmission electron microscope with respect to a region after 10,000-fold enlargement of the analysis surface.

23. The evaluation method for an alumina composite sintered body according to claim 20, wherein the concentration A of said fine particles contained in said analysis surface is measured by performing a mapping analysis via a high-angle annular dark-field method using a field effect-scanning transmission electron microscope with respect to a region after 10,000-fold enlargement of the analysis surface.
